(19) United States
(12) Patent Application Publication
(10) Pub. No.: US 2010/0145794 A1
(43) Pub. Date: Jun. 10, 2010

(54) Media Processing Engine and Ad-Per-View

(76) Inventors: Sean Barnes Barger, Mill Valley, CA (US); Steve Johnson, Mill Valley, CA (US); David Pochron, Cambridge, WI (US); Jerry Destremps, Sausalito, CA (US); Trent Brown, San Anselmo, CA (US)

Correspondence Address: GLENN PATENT GROUP, 3475 EDISON WAY, SUITE L, MENLO PARK, CA, 94025, US

(21) Appl. No.: 12/489,308

(22) Filed: Jun. 22, 2009

Related U.S. Application Data
(63) Continuation-in-part of application No. 11/269,916, filed on Nov. 7, 2005, now abandoned.
Application No. 11/269,916 is a continuation-in-part of application No. 09/929,904, filed on Aug. 14, 2001, now Pat. No. 6,964,009.
Application No. 09/929,904 is a continuation of application No. 09/425,326, filed on Oct. 21, 1999, now Pat. No. 6,792,575.
(60) Provisional application No. 61/074,519, filed on Jun. 20, 2008.

(51) Int. Cl. G06Q 30/00; G06F 17/00; G06Q 10/00; G06F 17/30; G06F 3/01; G06F 15/16

(52) U.S. Cl. 705/14.45; 700/94; 705/14.52; 707/802; 715/205; 715/760; 709/206; 707/E17.044

(57) ABSTRACT

A scaleable server-based, on-demand media processing engine automates the production and delivery of media. A digital processing engine automatically transcodes a plurality of media files having different formats into a composite media file.

### CROSS REFERENCE TO RELATED APPLICATIONS

This application claims priority to U.S. Patent Application Ser. No. 61/074,519 filed 20 Jun. 2008, and is a Continuation-in-Part of U.S. patent application Ser. No. 11/269,916, filed Nov. 7, 2005, which is a Continuation-in-Part of U.S. Ser. No. 09/929,904, filed Aug. 14, 2001, now U.S. Pat. No. 6,964,009 granted on Nov. 8, 2005, which is a Continuation of U.S. Ser. No. 09/425,326, filed Oct. 21, 1999, now U.S. Pat. No. 6,792,575, granted on Sep. 14, 2004, all of which are hereby incorporated in their entireties by reference.

### BACKGROUND OF THE INVENTION

1. Technical Field

The invention relates generally to processing and delivery of digital media, and more specifically delivery of automatically processed media to Web sites for access by an end user; auto-assembly of digital content; dynamically inserting profile-targeted video advertisements into multimedia content; and transmission of composite digital media comprising digital content and digital advertising.

2. Description of the Related Art

Building Web sites today is labor intensive. From the individual publishing a simple online technology newsletter from his home, to the Fortune 1000 company's multi-tiered site with hundreds of pages of text, images, and animations, the Web developer and each of his HTML-coding and graphics-producing coworkers toil page by page and image by image. Many established online companies employ numerous highly-skilled workers just to produce and maintain their Web sites. After all, the Web is now a major selling vehicle and marketing medium for many of these companies. The prevalence of the Web has brought forth dedicated service industries for Web development.

Established WYSIWYG tools exist in the industry for Web Site development. However, using such tools, a Web developer still must produce each page on a Web site one by one. The same applies to preparing and placing images, animations, and other visual assets. Each page presents its own set of issues ranging from whether to use GIF, JPEG, or PNG file formats, to finding the optimum bit depth for each image to ensure the fastest downloading through the different browsers of the consumer. The estimated development time for a typical site is approximately two hours per page.

State of the art web sites offer users zooming and panning capabilities, so that by clicking on an image a user can view content more closely or from a different angle. On the horizon are pages with three-dimensional imagery that enable a user to move around a page looking more like a room than a brochure. While interesting, these features are merely incremental improvements to a consumer's surfing experience.

D. C. A. Bulterman, Models, Media, and Motion: Using the Web to Support Multimedia Documents, Proceedings of 1997 International Conference on Multimedia Modeling, Singapore, 17-20 Nov. 1997 discloses “an effort underway by members of industry, research centers and user groups to define a standard document format that can be used in conjunction with time-based transport protocols over the Internet and intranets to support rich multimedia presentations. The paper outlines the goals of the W3C′s Synchronized Multimedia working group and presents an initial description of the first version of the proposed multimedia document model and format.”

Text and Graphics on UMI's ProQuest Direct: The Best (yet) of both Worlds, Online, vol. 21, no. 2, pp. 73-7, March-April 1997 discloses an information system that offers “periodical and newspaper content covering a wide range of business, news, and professional topics . . . letting the user search both text and graphics and build the product to suit. Articles can be retrieved in varying levels of detail: citation, abstracts, full text, and text with graphics. Images come in two flavors: Page Image, a virtual photocopy, and Text+Graphics, in which graphics are stored separately from the text and are manipulable as discrete items. . . . [The system] comes in two versions: Windows and Web.”

John Mills Dudley, Network-Based Classified Information Systems, AU-A-53031/98 (27 Aug. 98) discloses a “system for automatically creating databases containing industry, service, product and subject classification data, contact data, geographic location data (CCG-data) and links to web pages from HTML, XML, or SGML encoded web pages posted on computer networks such as Internets or Intranets. . . . The . . . databases may be searched for references (URLs) to web pages by use of enquiries which reference one or more of the items of the CCG-data. Alternatively, enquiries referencing the CCG-data in the databases may supply contact data without web page references. Data duplication and coordination is reduced by including in the web page CCG-data display controls which are used by web browsers to format for display the same data that is used to automatically update the databases.”

Cordell et al, Automatic Data Display Formatting with A Networking Application, U.S. Pat. No. 5,845,084 (Dec. 1, 1998) discloses a placeholder image mechanism. “When a data request is made, the data transfer rate is monitored. When the receive data transfer rate is slow, and the data contains an embedded graphical image of unknown dimensions, a small placeholder image is automatically displayed for the user instead of the actual data. The small placeholder image holds a place on a display device for the data or the embedded graphical image until the data or embedded graphical image is received. When embedded graphical image is received, the placeholder image is removed, and the display device is reformatted to display the embedded graphical image.”

Jonathon R. T. Lewis, System For Substituting Tags For Non-Editable Data Sets In Hypertext Documents And Updating Web Files Containing Links Between Data Sets Corresponding To Changes Made To The Tags, U.S. Pat. No. 5,355,472 (Oct. 11, 1994) discloses a “hypertext data processing system wherein data sets participating in the hypertext document may be edited, the data processing system inserting tags into the data sets at locations corresponding to the hypertext links to create a file which is editable by an editor and the data processing system removing the tags, generating a revised data set and updating the link information after the editing process. Its main purpose is to preserve the linking hierarchy that may get lost when the individual data sets get modified.”

Wistendahl et al, System for Mapping Hot Spots in Media Content Interactive Digital Media Program, U.S. Pat. No. 5,708,845 (Jan. 13, 1998) discloses a “system for allowing media content to be used in an interactive digital media (IDM) program [that] has Frame Data for the media content and object mapping data (N Data) representing the frame addresses and display location coordinates for objects appearing in the media content. The N Data are maintained separately from the Frame Data for the media content, so that the media content can be kept intact without embedded codes and can be played back on any system. The IDM program has established linkages connecting the objects mapped by the N Data to other functions to be performed in conjunction with display of the media content. Selection of an object appearing in the media content with a pointer results in initiation of the interactive function. A broad base of existing non-interactive media content, such as movies, videos, advertising, and television programming can be converted to interactive digital media use. An authoring system for creating IDM programs has an object outlining tool and an object motion tracking tool for facilitating the generation of N Data. In a data storage disk, the Frame Data and the N Data are stored on separate sectors. In a network system, the object mapping data and IDM program are downloaded to a subscriber terminal and used in conjunction with presentation of the media content.”

Rogers et al, Method for Fulfilling Requests of A Web Browser, U.S. Pat. No. 5,701,451 (Dec. 23, 1997) and Lagarde et al, Method for Distributed Task Fulfillment of Web Browser Requests, U.S. Pat. No. 5,710,918 (Jan. 20, 1998) discloses “improvements which achieve a means for accepting Web client requests for information, obtaining data from one or more databases which may be located on multiple platforms at different physical locations on an Internet or on the Internet, processing that data into meaningful information, and presenting that information to the Web client in a text or graphics display at a location specified by the request.”

Tyan et al, HTML Generator, European Patent Application No. EP 0843276 (May 20, 1998) discloses “generating an HTML file based on an input bitmap image, and is particularly directed to automatic generation of an HTML file, based on a scanned-in document image, with the HTML file in turn being used to generate a Web page that accurately reproduces the layout of the original input bitmap image.”

TrueSpectra has a patent pending for the technology employed in its two products, IrisAccelerate and IrisTransactive. These products are designed for zooming and panning and simple image transformations and conversions, respectively. They support 10 file formats and allow developers to add new file formats via their SDK. They do not require the use of Flashpix for images. However, their documentation points out that performance is dependent on the Flashpix format. The system would be very slow if a non-Flashpix format were used.

TrueSpectra allows the image quality and compression to be set for JPEGs only. The compression setting is set on the server and all images are delivered at the same setting.

TrueSpectra has a simple caching mechanism. Images in the cache can be cleared out automatically at certain times. There are no dependency features for image propagation. The Web server needs to be brought down in order to update any original assets.

TrueSpectra does not require plug-ins to operate features such as zooming/panning or compositing. The alternative to plug-ins is using JavaScript or active server page technology. These technologies are used by many Web sites to provide interactivity, but not all Web browsers work correctly with these technologies.

TrueSpectra relies on Flashpix as its native file format and does not support media types such as multi-GIFs and sound formats. Flashpix files are typically larger than many file formats. Access to files is faster for zooming and panning, but appears to be quite slow.

The key to IrisTransactive is the compositing subsystem. It requires three things to build a shopping solution using image composition. The original images must be created. It is suggested that the image be converted to Flashpix for better performance. All of the individual images must be described in XML using the image composer program. The program allows the editor to specify anchor points, layer attributes, and layer names. The resulting file is between 5 k and 50 k. The Web designer must place HTML referring to the XML in the Web site. By specifying parameters to the XML, the Web designer can turn on or off layers.

The above-described process for compositing images enables Web designers to create shopping sites. However, a lot of overhead results. The XML documents add 5 k-50 k to a Web site. The compositing commands that are embedded in the HTML are difficult to understand. And, because the compositing feature requires several steps to implement, it is not suitable for every image on a Web site. The process seems to be designed for the specific purpose of shopping.

MediaBin™ is limited to activities behind the firewall automating only the “post-creative busywork.” In addition, MediaBin requires the use of an application server to function through a web interface. Thus images may not be directly added to any existing web page.

Macromedia's Generator operates by embedding variables in their proprietary Flash format. Therefore the actual imaging operations are somewhat limited and cannot be controlled directly from a web page request.

MGI Software sells point solutions that require end-users to download a viewer to process a proprietary image format.

PictureIQ offers a server-side image-processing appliance that provides a limited set of Photoshop functionalities. This appliance runs on the web-page server, processes information embedded in the web page, and rewrites the web page with image data.

The above-disclosed approaches are lacking in the speed with which they can modify and add images, video, and sound to sites, in the volume of data they can publish internally and externally, and in the quality of the output.

As explained above, most digital video is edited manually. Video developers typically employ the following basic process. First, they manually gather digital content. Next, they separately convert each digital clip from one format to a second desired format which may require one or more expensive software programs. Next, the developers splice the various digital clips. Assuming the developers wish to add auxiliary content, such as advertisements, they decide what advertisement content to include in various ad slots within the digital content. Even this simple workflow is laborious and time consuming. Adding other functions and capabilities such as zooming, interactivity, three-dimensionality and other emerging features makes manual content creation and editing extremely time consuming. Additionally, adding content in creative advertisement slots and including advertisement effectiveness metrics compounds the problem.

In recent years, the consumption of digital media has rapidly expanded. With the advent of personal digital music and digital video players, the demand for content has increased rapidly. Currently, users wishing to obtain multimedia content for their devices must find data in a compatible form, or alternatively, they must convert the files manually. Generally, decoding media from one format and converting into a second is difficult and time-consuming and is directly at odds with the advantages of personal digital media devices, namely to provide convenience.

Another shortcoming present in the current state of the art is the complexity in the insertion of advertisements into media, maintaining control of advertisements and ensuring the effectiveness of advertisements in digital media. Advertisers wishing to insert their brand marketing into digital content are presented with a number of hurdles. First, the present state of the art requires the advertisers to provide compatible file formats upfront. Current systems do not support all types of media players or provide advertisers with the ability to access their video advertisement content, regardless of the format. Nor do current systems enable advertisers to have adequate control over their ads, i.e. where the ads go, when, for how long, etc.

Existing online ad networks cannot simply be extended to handle video advertising, since they are insufficiently automated, and lack the computing sophistication needed to manipulate very large, complex video files on the massive scale that entertainment publishers and advertisers require.

Additionally, in the current state of the art, there are not adequate metrics for ensuring effectiveness of an advertisement campaign. Ad-industry veterans report difficulty measuring the effectiveness of specific advertisement campaigns on consumers' purchasing behavior. Print advertisements in magazines may result in persuading the target audience to purchase a product, but measurements are too coarse, and the time lag between an advertisement's “impression” on the reader and his subsequent product purchase is not measurable. Measuring the effectiveness of TV broadcast advertisements is somewhat easier, but entirely statistical (increase seen in total sales of new product X after 30 days of airing ad Y in regional market Z). There is still no immediate feedback.

Online digital video advertising changes the landscape. Viewers can interact with advertisements on a Web page, and their behavior tracked & recorded. An advertisement's effectiveness can be measured by measuring the amount of click-through traffic it generates to a Web site. Its popularity (or “viralness”) can be measured by various metrics.

It would be desirable to address the above-described shortcomings.

### SUMMARY OF THE INVENTION

A massively scaleable server-based, on-demand media processing engine gives digital content providers access to digital media consumers, deploys advertisement management capabilities to advertisers, and automates the production of composite digital media to target users.

An enterprise class server architecture is provided for assembling and distributing composite digital content and advertisement of all types to all types of devices. In some embodiments, content providers establish an account with the enterprise. According to these embodiments, content providers can release content along with a media delivery bar. In some embodiments, an advertiser creates an account with the enterprise and manages an ad campaign using a main administration user interface.

In some embodiments, a media processing engine ingests con tent owners' media, advertisers' ad content, details of an advertisement campaign, and an end-user's output requirements to construct a workflow for the creation of a new media asset. The media processing engine then auto-assembles new, composite media comprising the content with targeted advertisements inserted therein.

The media processing engine takes advantage of an advertisement engine that integrates advertising within a media file that is relevant to the end user. In some embodiments, the advertising engine uses end-user demographic information to make a relevance decision. In some embodiments, the advertising engine also has effectiveness-measuring capabilities to track advertising inventory that has been inserted into various media.

The media processing engine uses a generated workflow comprising instructions to transcode a media file and to re-purpose the file in a different file format through digital funneling. Digital funneling results in an output-device defined new composite media file that is delivered (or deliverable) to an end-user's device.

### BRIEF DESCRIPTION OF THE DRAWINGS

FIG. 1A is a schematic diagram showing the basic system placed within a network infrastructure according to some embodiments of the invention;

FIG. 1B illustrates another embodiment of the basic system for ingesting content and advertising, and for outputting composite media according to some embodiments of the invention;

FIG. 1C illustrates a schematic of a basic method of media delivery according to some embodiments of the invention;

FIG. 1D illustrates a schematic of high-level overview of media delivery according to some embodiments of the invention;

FIG. 1E illustrates a schematic of an ingestor service according to some embodiments of the invention;

FIG. 1F illustrates a schematic diagram of the main administrative web application in the media delivery system according to some embodiments of the invention;

FIG. 2A illustrates a schematic representation of the modular system organized into modules according to some embodiments of the invention;

FIG. 2B illustrates a schematic representation of an alternative modular system according to some other embodiments of the invention;

FIG. 3A illustrates a basic flowchart showing the steps for a content provider to follow for delivering their content with an integrated media delivery bar according to some embodiments of the invention;

FIG. 3B illustrates an example of a video asset configured with a media delivery bar according to some embodiments of the invention;

FIG. 3C illustrates an example of a video asset configured with a media delivery bar providing delivery options according to some embodiments of the invention;

FIG. 3D illustrates an example of a video asset configured with a media delivery bar providing delivery methods according to some embodiments of the invention;

FIG. 3E illustrates an example of a video asset configured with a media delivery bar providing a demographic submenu according to some embodiments of the invention;

FIG. 4A illustrates a hosted interactive website with a series of tabs indicating various functions of the website according to some embodiments of the invention;

FIG. 4B illustrates an embodiment of a hosted interactive website showing the content and functionality of the assets tab having an Asset Upload field according to some embodiments of the invention;

FIG. 4C illustrates an embodiment of a hosted interactive website showing the content and functionality of the demographics tab according to some embodiments of the invention;

FIG. 4D illustrates an embodiment of a hosted interactive website showing the content and functionality of the channels tab according to some embodiments of the invention;

FIG. 4E illustrates an embodiment of a hosted interactive website showing the content and functionality of the campaign tab according to some embodiments of the invention;

FIG. 4F illustrates a schematic representation of a set of candidate advertisement assets according to some embodiments of the invention;

FIG. 4G illustrates a schematic representation of a selection interface for associating demographic choices to individual advertisement assets according to some embodiments of the invention;

FIG. 4H illustrates a schematic representation of a whole campaign demographic selection interface according to some embodiments of the invention;

FIG. 4I illustrates a schematic representation of a demographic selection interface shown to a content consumer in a media delivery bar according to some embodiments of the invention;

FIG. 4J illustrates schematic representation of an interface for an advertisement provider to indicate whether to accept or reject advertisements when a demographic characteristic is unspecified according to some embodiments of the invention;

FIG. 4K illustrates a schematic representation of an advertisement asset list output by the advertisement selection algorithm according to some embodiments of the invention;

FIG. 4L illustrates an embodiment of an advertisement selection algorithm represented in psuedocode according to some embodiments of the invention;

FIG. 5A illustrates a schematic representation of an exemplary process defined by a request for content according to some embodiments of the invention;

FIG. 5B illustrates a representation of an example of a new composite media definition according to some embodiments of the invention;

FIG. 5C illustrates an example of a composite media definition after advertisements have been selected for the ad slots wherein the advertisements comprise diverse audio/video file formats according to some embodiments of the invention;

FIG. 5D illustrates an alternative representation of an alternative method for delivering digital media according to some embodiments of the invention;

FIG. 6A illustrates a schematic representation of a on-the-fly video export process used in digital funneling according to some embodiments of the invention;

FIG. 6B illustrates an exemplary digital audio/video funneling process according to some embodiments of the invention;

FIG. 6C illustrates a schematic representation of a on-the-fly audio synchronization process used together with the video processing for digital funneling according to some embodiments of the invention;

FIG. 6D illustrates one example of assembling a user-defined composite media file from a plurality of input files according to some embodiments of the invention; and

FIG. 6E illustrates another example of assembling a user-defined composite media file from a plurality of input files according to some embodiments of the invention.

### DETAILED DESCRIPTION OF THE INVENTION

### System Overview

A server-based processing engine ingests digital media and advertisement content, assembles composite content and distributes the composite content in any desired format to all types of devices.

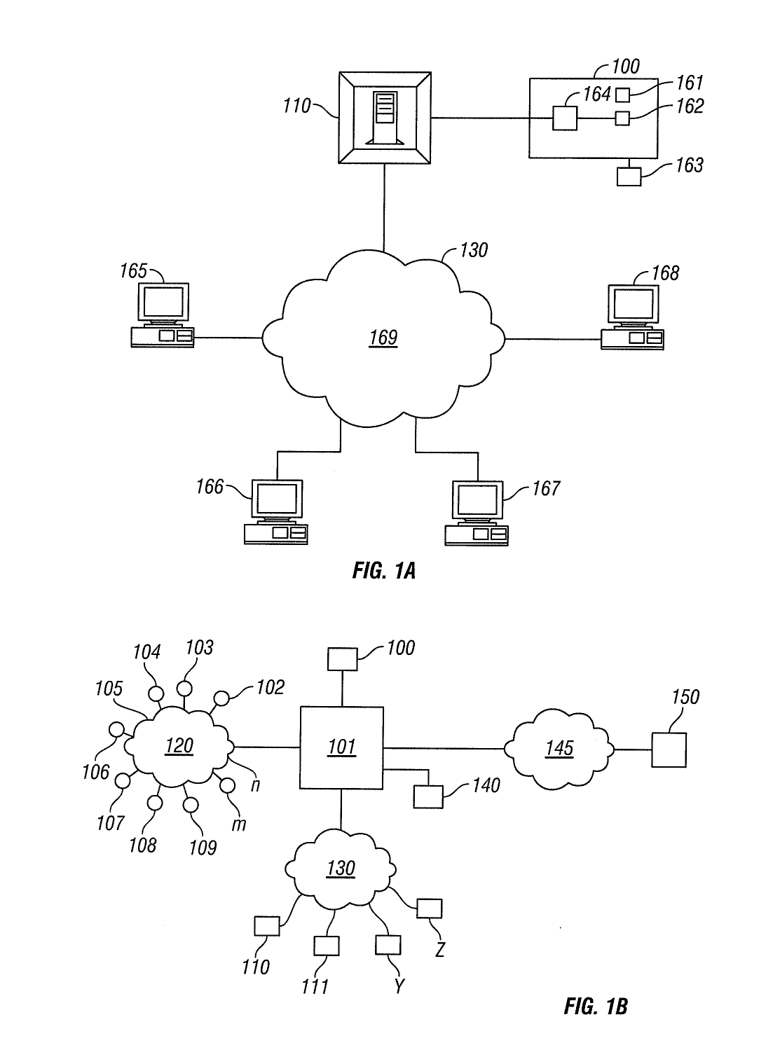

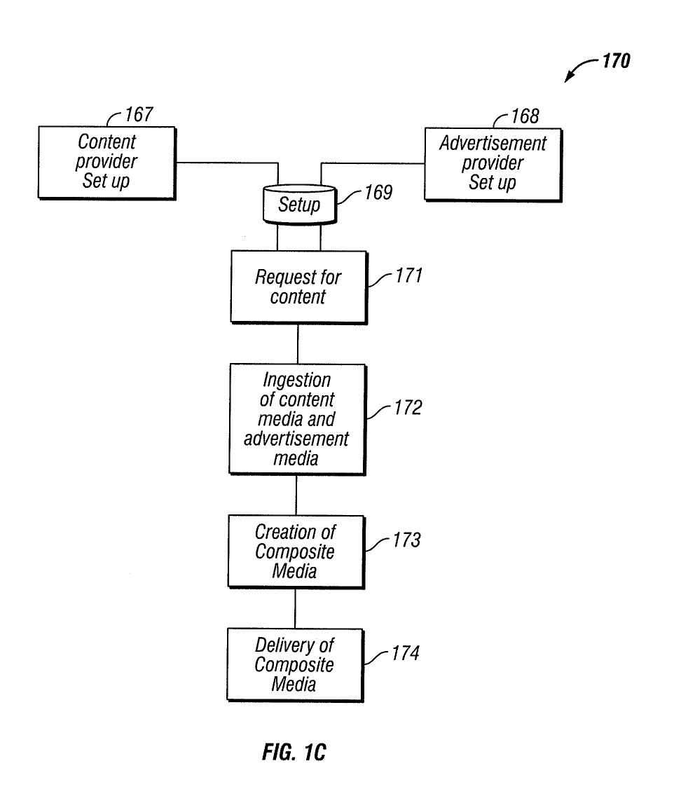

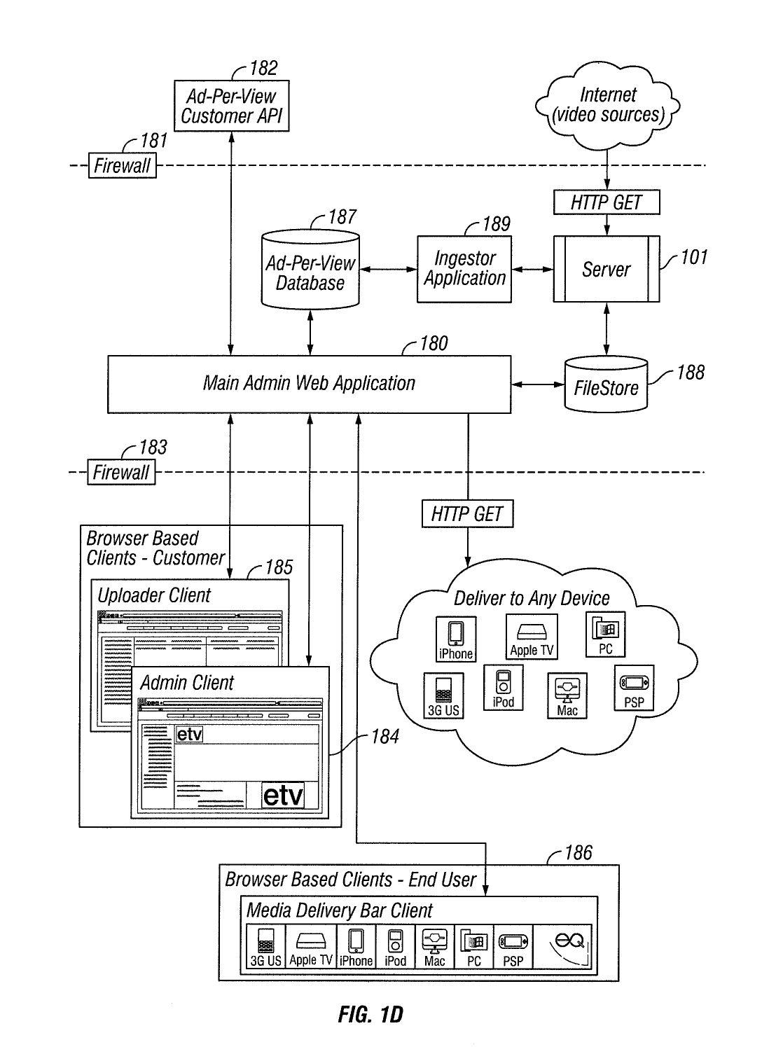

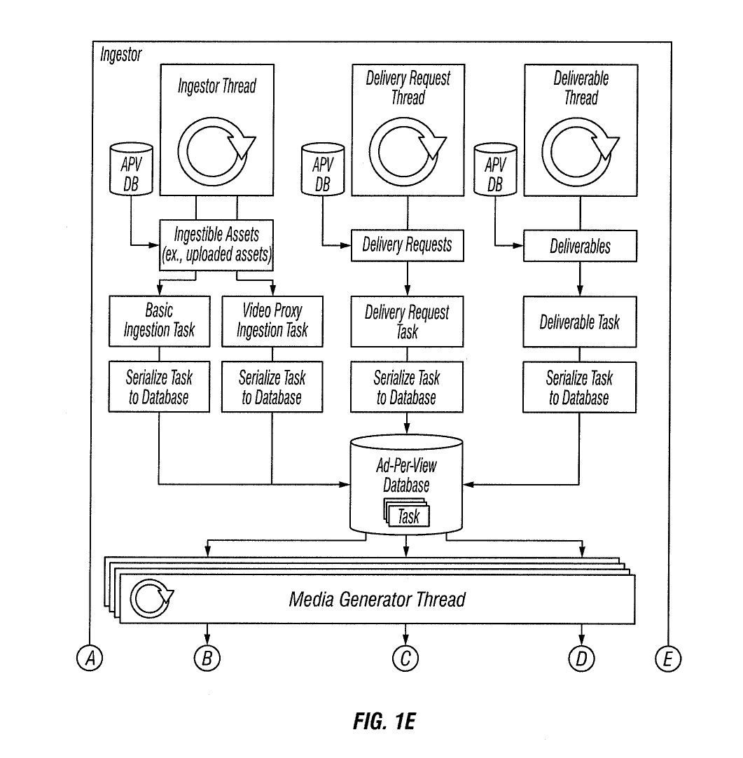

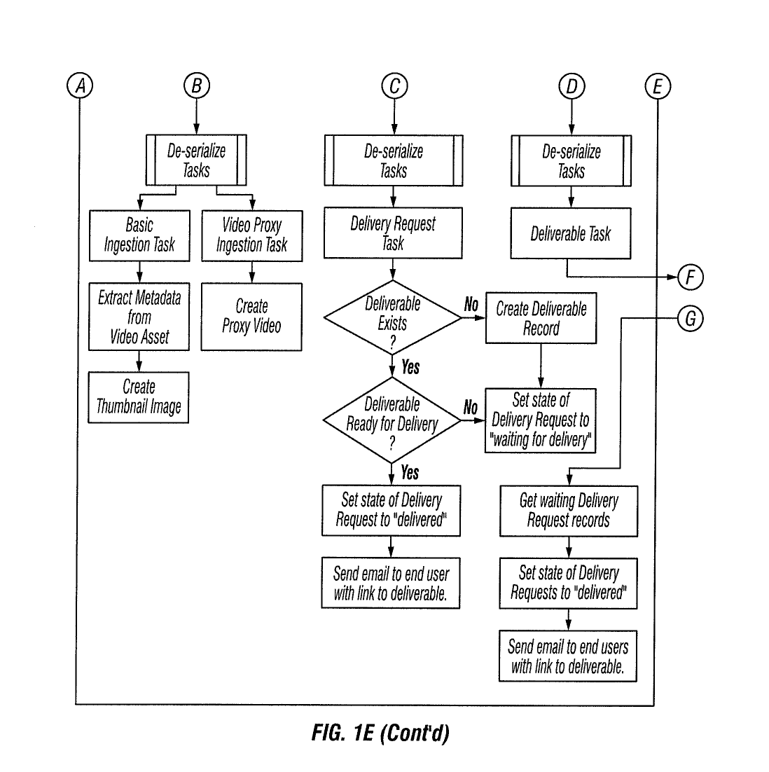

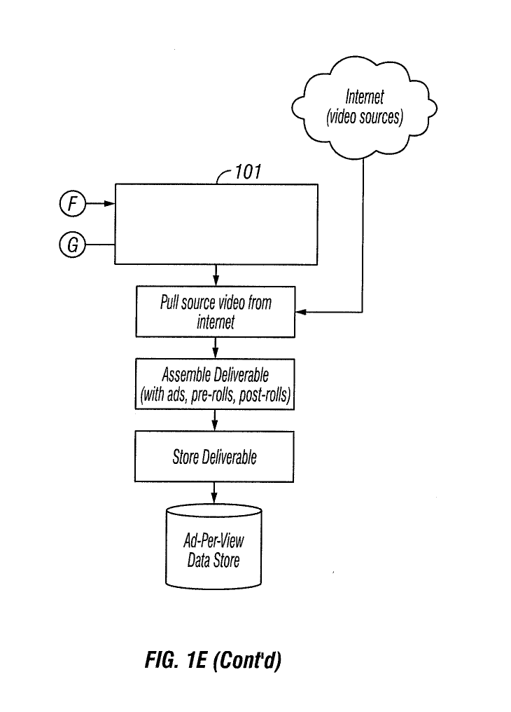

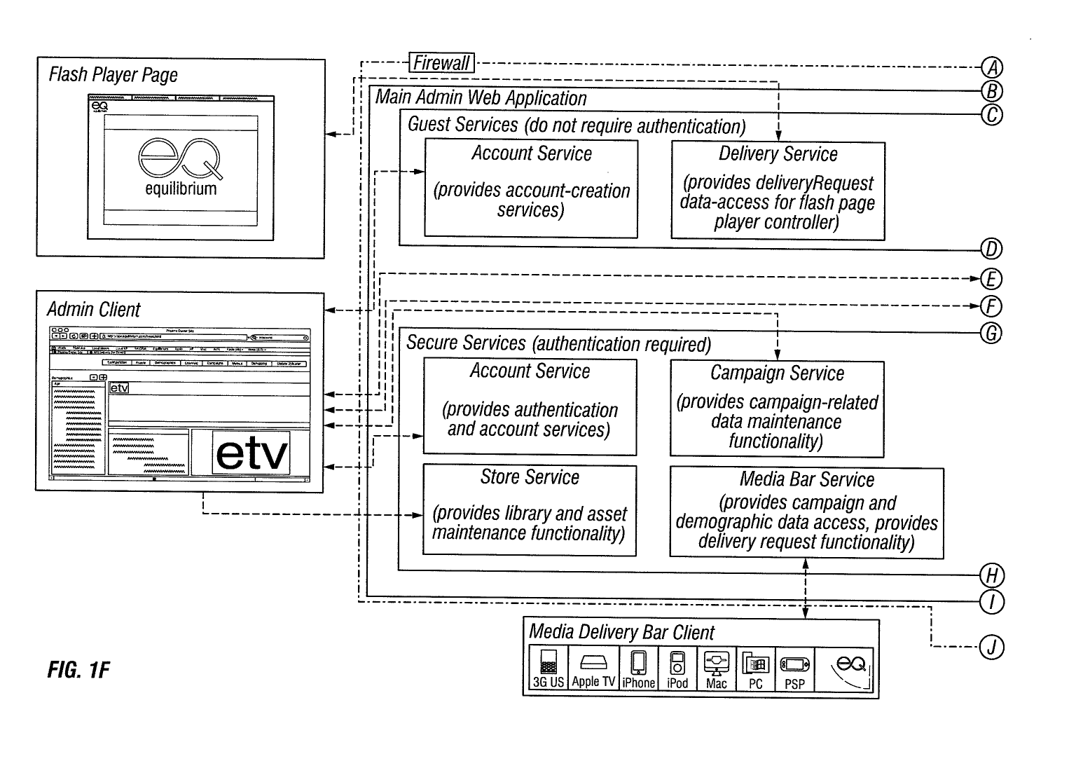

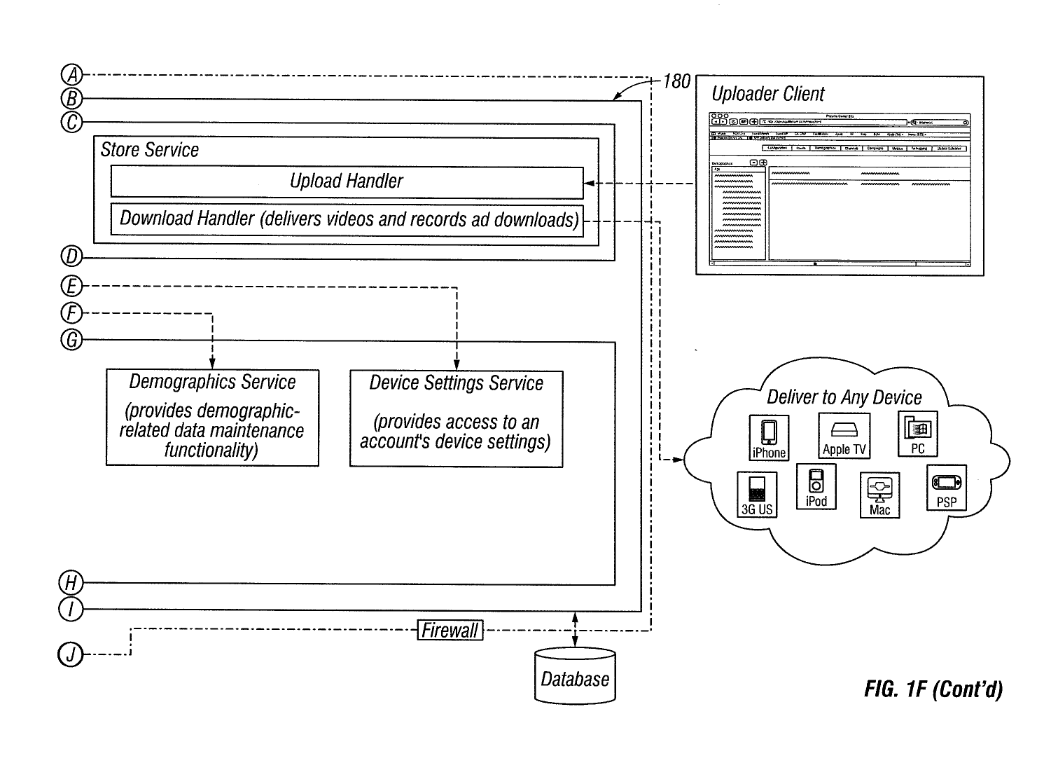

FIG. 1A is a schematic diagram showing a digital media processing system 100 placed within a network infrastructure according to the presently preferred embodiment of the invention. The system 100 comprises memory 161 and a processor 162 configured to store and process computer readable instructions for carrying out the automatic media delivery system according to the invention. The system optionally includes an interface 163 comprising a Graphical User Interface (GUI) for allowing a human user to interface the automatic media delivery system. The processor 162 is also coupled with a network interface 164 such that the system 100 may communicate with one or more web servers 110. In the presently preferred embodiment, the system 100 is coupled with a web server 110, which is coupled to multiple devices and providers 165, 166, 167, 168 via a network 169, such as the Internet.

FIG. 1B illustrates another embodiment of the system 100 for ingesting content and advertising, and for outputting composite media according to some embodiments of the invention. The system 100 accesses one or more sources of digital content via a server 101. The server 101 can be configured to access digital video content including digital video entertainment and digital video advertisement. In some embodiments of the present invention, the server 101 includes a processing unit having associated memory and I/O capabilities.

The server 101 is coupled to a network 120 which is coupled to one or more external storage repositories and/or one or more sources of digital content. In some embodiments of the invention, the server 101 has access to a network storage 102, an HTTP server 103, an FTP server 104, a content management system repository 105, content stored in a database 106, broadcasted digital media 107, web-streaming digital media 108, video on demand content 109, and/or other sources m, n of digital media now known or later developed.

In some embodiments of the invention, the server 101 has access to digital content locally via local disk 140. The local disk 140 is selected from any number of digital content sources including, but not limited to compact disc players, digital video disc players, high definition digital video disc players, blue-ray disc players, MP3 players, personal data assistant (PDA) devices, Iphone™ devices, smartphones, and hard drives storing digital content. Likewise, the server 101 is configured to access digital advertisement content from an existing advertisement serving database 150 via a network 145.

One or more clients 110, 111, y, and z are also coupled with the server 101 via a network 130. The one or more clients 110, 111, y, and z comprise authors, distributors, providers of digital media (referred to as “content providers”); providers of digital advertisement content (referred to as “ad providers”); and/or individuals who desire delivery of content and advertisement (referred to as “content consumers”).

FIG. 1C illustrates a schematic of the basic method of media delivery 170 according to the invention. The method of media delivery 170 begins with setup 169. Setup 169 comprises content provider setup 167 (explained below) and advertisement provider setup 168 (explained below). The method of media delivery 170 continues with content consumers requesting content 171 from one or more content providers. Next, the system ingests 172 content media as well as advertisement media from the content providers and ad providers. Next, the system creates 173 composite media comprising the content seamlessly integrated with the advertising. The composite media settings can be based on the requestor's playback requirements (explained below). Finally, the composite media is delivered 174 to the content consumers.

FIG. 1D illustrates a schematic of the main administrative interface of a media delivery system according to some embodiments of the invention. According to FIG. 1D, a main administrative web application 180 communicates with customers and clients in a variety of ways. The main administrative web application 180 communicates over a firewall 181 via an Ad-Per-View customer API 182, over a firewall 183 to browser-based administrative clients 184 and uploader clients 185, and to browser-based end users 186. In some embodiments, the main administrative web application 180 communicates via Action Message Format. The main administrative web application 180 accesses media from a number of sources including an ad database 187 and a Filestore database 188. The ad database 187 obtains media metadata from the server 101 via an ingestor application 189. FIG. 1E illustrates a schematic of an ingestor service in communication with the server 101 according to some embodiments of the invention. Likewise, the filestore 188 obtains media from the server 101. As explained above, the server 101 accesses media from a variety of sources. In the example shown, in FIG. 1D, the server 101 obtains media from the internet 199 via an http request.

FIG. 1F illustrates a more detailed schematic diagram of the main administrative web application 180 in the media delivery system according to the invention. As shown, the main administrative web application 180 performs guest services and secure services for established accounts.

The main administrative web application 180 performs guest services that do not require user authentication. Examples of guest services include, but are not limited to: account creation services; delivery services (i.e. Flash Player delivery); and storage services (i.e. via an upload client). In some embodiments of the invention, the main administrative web application 180 offers an uploader client application download for all supported devices.

Additionally, the main administrative web application 180 performs secure services for an established account which require user authentication. The process of creating accounts for content providers and advertisement providers is explained in more detail below. Briefly, a list of services for established accounts include, but is not limited to: account services; advertisement campaign services; demographic services, device settings services; storage/caching services; and media bar services.

### Modular Representation

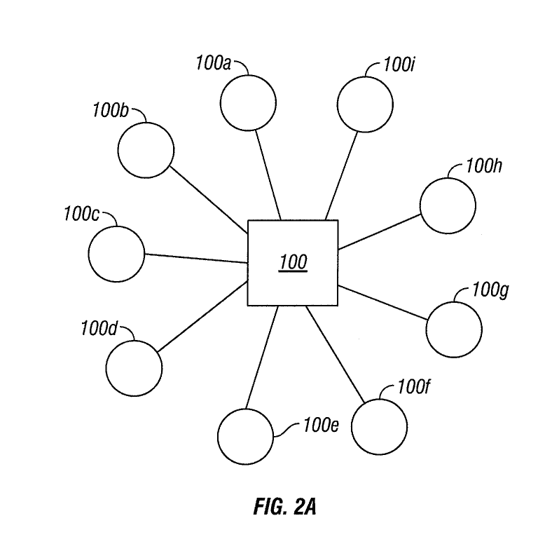

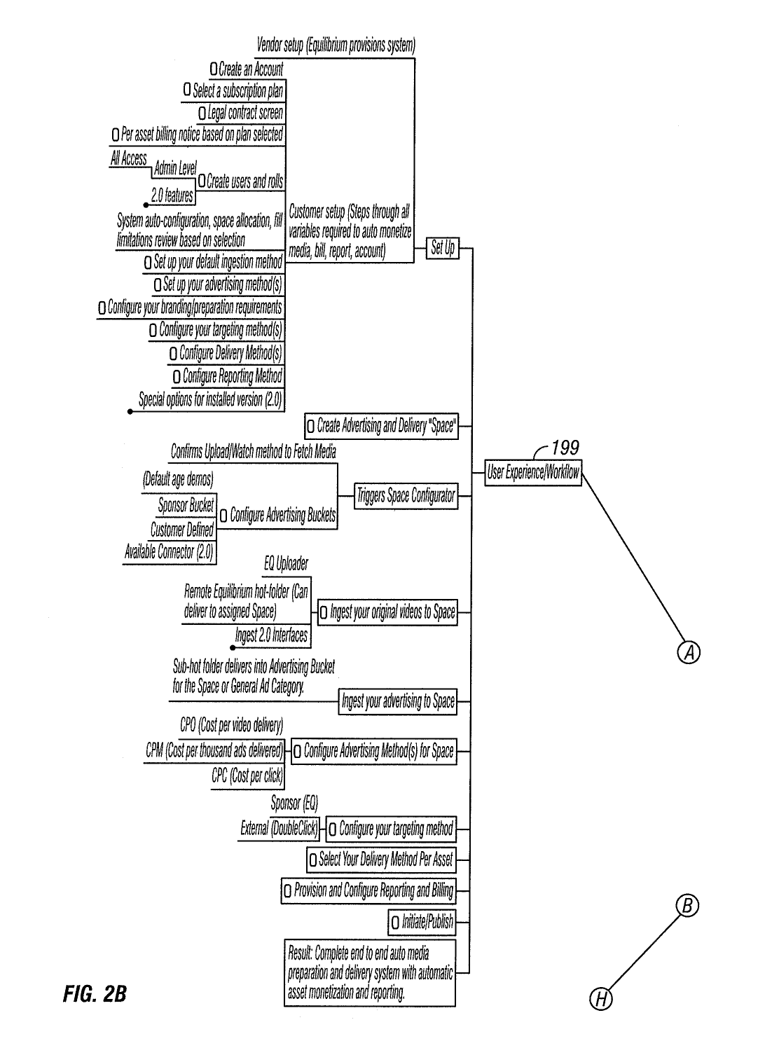

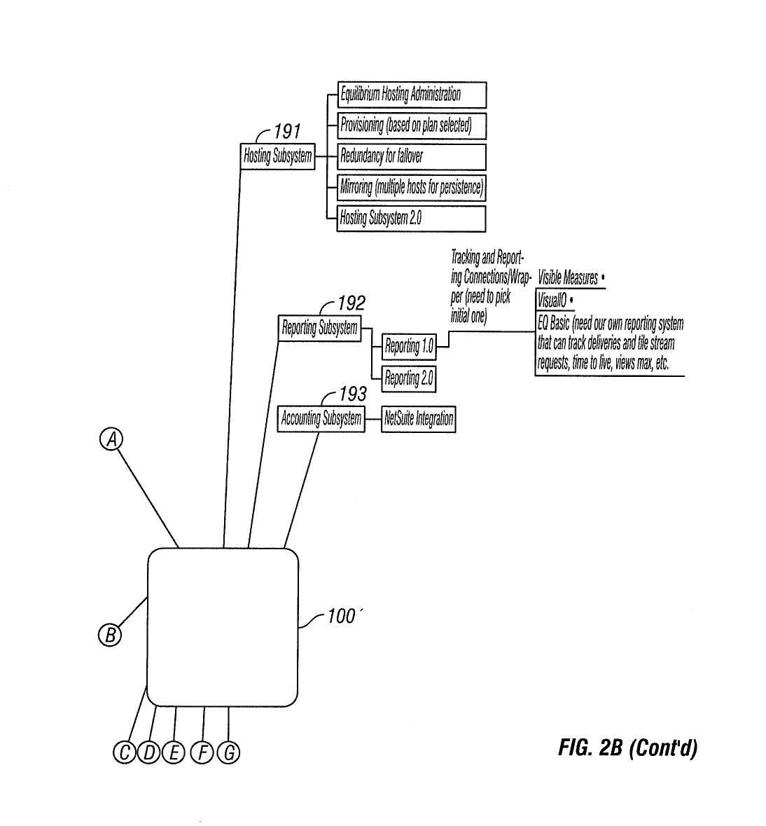

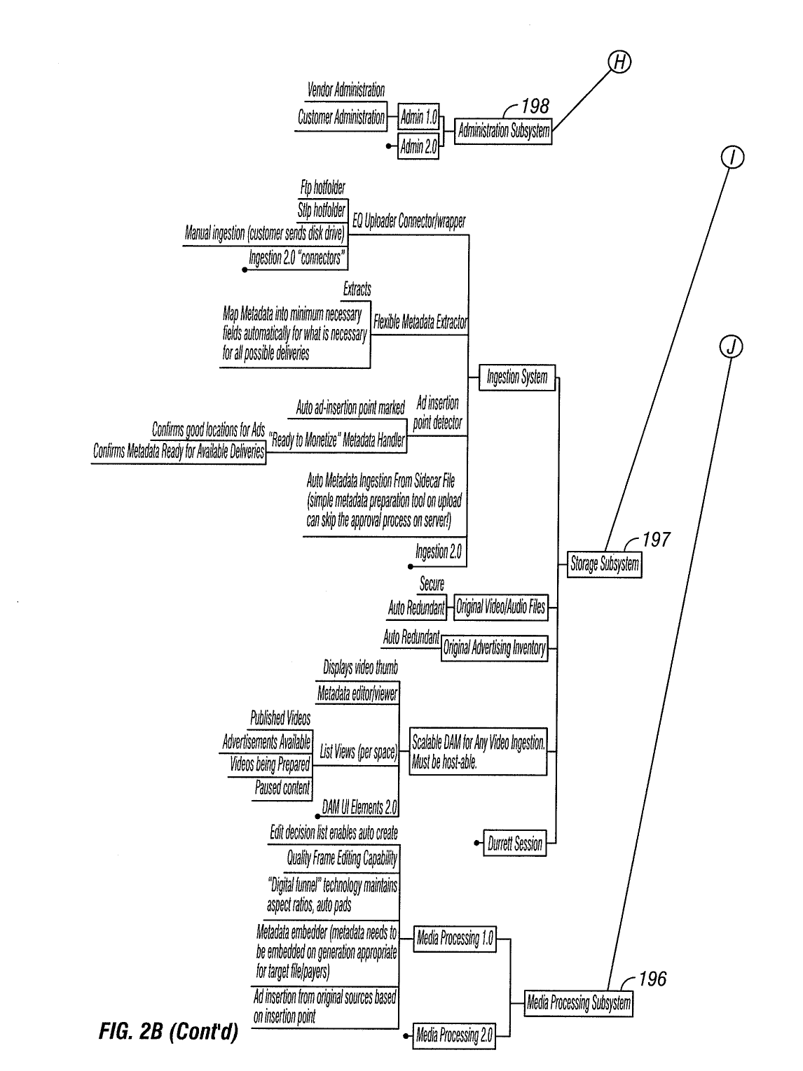

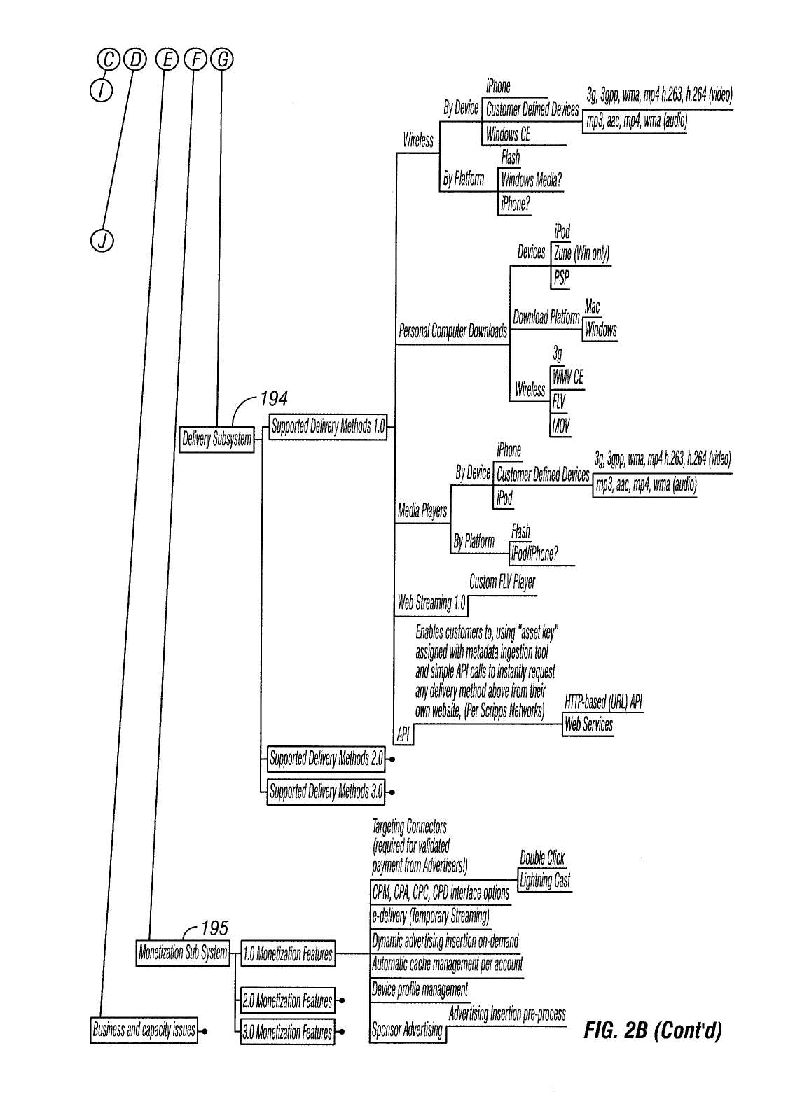

The system 100, described in conjunction FIGS. 1A through 1F above, includes various subsystems for carrying out content deployment, advertisement management, advertisement tracking, monetization management, media transcoding, auto-assembly, and storage of previously ingested media, among other capabilities. FIG. 2A illustrates a schematic representation of the system 100 organized into modules 100a-100i according to some embodiments of the invention. As shown, the system 100 includes a user interface module 100a, an administrative module 100b, an administration-side storage/caching module 100c, a media processing module 100d, a hosting module 100e, an administrative reporting module 100f, an administrative accounting module 100g, a media delivery module 100h, and a monetization module 100i.

According to some embodiments, a user interface module 100a provides users with a graphical user interface that walks the user through one or more tasks. In some embodiments, the user interface module 100a provides an interface with tools for content owners and advertisement suppliers to set up an account, tools for the ingestion of media and advertisements from the users, tools for configuring preferences, and/or tools publishing content and initiating an advertisement campaign.

In some embodiments, an administrative module 100b provides tools to an administrator of the system 100 to organize the status of users, evaluate permissions, etc. In some embodiments of the invention, a storage/caching module 100c includes a media ingestion and caching subsystem, an inventory of media/advertisement files, and a digital asset management subsystem. Exemplary systems and methods for the automated processing and delivery of media to a webserver are described in commonly-owned U.S. Pat. No. 6,792,575, granted on Sep. 14, 2004, which is hereby incorporated in its entirety by reference.

In some embodiments of the invention, a media processing module 100d automates the production of images, animations and video, and enables end-to-end delivery of assembled media assets to any device/platform. Examples of typical destinations include IP television, broadcast television, video on-demand, web streaming, computer downloads, media players, cellular devices, personal digital assistants, smart-phones and web pages. The media processing module 100d is configured to auto-assemble programs on the fly as they are deployed in addition to adding advertisements. The media processing module 100d is explained in greater detail below.

In the presently preferred embodiment of the invention, the media processing module 100d includes a storage subsystem containing a plurality of decoding modules. Each of the plurality of decoding modules contains instructions for decoding one or more media file types. For example, one particular decoding module may include instructions for transcoding a Quicktime Movie file format into a Windows Media Player file format. According to these embodiments, new and different media players and media formats are easily able to be added to the system. In some embodiments, new media file types are enabled to be output by the system by simply placing a decoding module into a settings file included in the storage subsystem of the media processing module 100d. For example, if a content provider wants the ability to delivery their content to devices containing new a proprietary format such as an Apple® Iphone™ file format, they simply add an Iphone™ settings file to the system and the Iphone™ is instantly supported on their site.

In some embodiments of the invention, a hosting module 100e is provided for managing the Ad-Per View system as explained below. In some embodiments of the invention, an administrative reporting module 100f and an administrative accounting module 100g are provided for tracking media deliveries, advertisement deliveries, accounting, etc.

In some embodiments of the invention, a media delivery module 100h is provided for managing the various methods of media delivery. For example, in presently preferred embodiments of the invention, the media delivery module 100h facilitates wireless media delivery to a plurality of wireless devices and for a plurality of platforms. In some embodiments of the invention, the media delivery module 100h supports personal computer downloads, dedicated media player delivery, web-streaming delivery, API call delivery, etc.

In some embodiments of the invention, a monetization module 100i is configured with a plurality of tools to provide effective advertisement delivery, metric tracking and accounting. In some embodiments of the invention, the monetization module 100i provides an interface for tracking novel advertisement metrics. In some embodiments of the invention, the monetization module 100i is configured to connect with existing ad-insertion providers, such as Double-Click and Lightning Cast. Advertisement-tracking metrics are explained in more detail below.

FIG. 2B illustrates a schematic representation of an alternative modular system according to some other embodiments of the invention. As shown in FIG. 2b, the system 100′ includes a user experience/workflow module 199, an administrative subsystem 198, a storage subsystem 197, a media processing subsystem 196, a monetization subsystem 195, a delivery subsystem 194, an accounting subsystem 193, a reporting subsystem 192, and a hosting subsystem 191.

### Client Interface-Content Provider Setup

Content providers will be drawn to the system disclosed herein because they want to monetize and mobilize their content by providing the content to any user and have the content wrapped with hyper-targeted advertisements. Additionally, content providers desire the ability to especially target mobile device users due to the increasing ubiquity of mobile devices capable of effectively processing media.

The rapidly growing audience of mobile content consumers and the increased amount of money that advertisers are willing to pay for highly relevant impressions increases the amount of advertisement revenue that the content provider may demand. By using the system disclosed herein, content providers are able to reach content consumers via a mobile device no matter what media format the device requires because the system allows the user to specify their device type without installing any plugins, and the Media Processing Module automatically transcodes and reformats the content to fit that device.

In the presently preferred embodiments of the invention, content providers can take advantage of the system by creating an account with the system via the graphical user interface. In some embodiments, content provider accounts are subscription based and may be tracked with an accounting subsystem, as explained above. Once an account is created, the system is ready to ingest media from content providers via an upload interface offered to the content providers via a graphical user interface.

In some embodiments, a graphical user interface provides content providers with an upload interface, as well as tools for defining advertisement slots for the media assets. For example, the content providers can specify at the time an asset is uploaded that they would like a pre-roll advertisement inserted in the asset, when delivered. Likewise, the content providers may specify that they would like their logo present in the corner of the delivered video throughout the delivery. It will be readily apparent to those with ordinary skill in the art, having the benefit of this disclosure, that any number of advertisement slots may be specified during this process.

In some embodiments, the graphical user interface provides a demographic entry interface where a content providers can specify certain demographic information they wish to obtain from a content consumer before delivery of an asset.

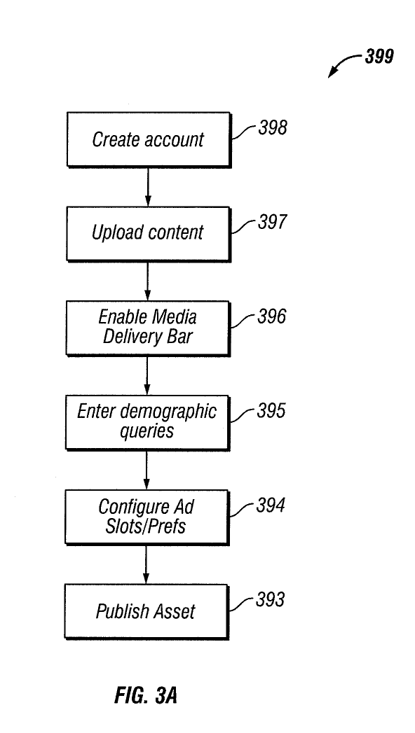

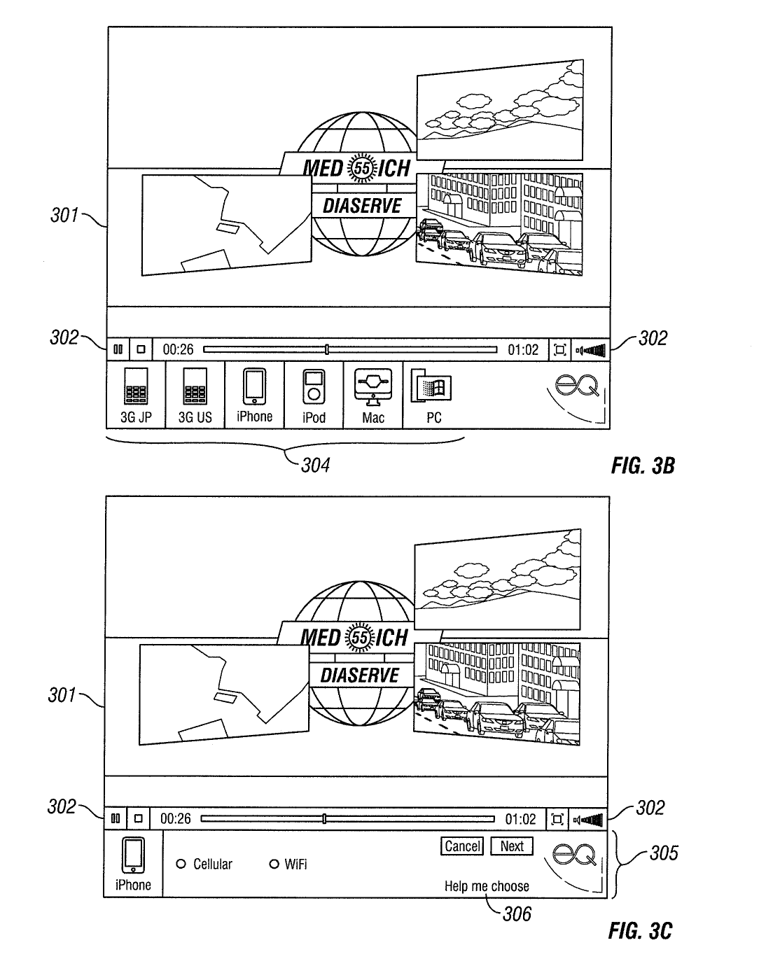

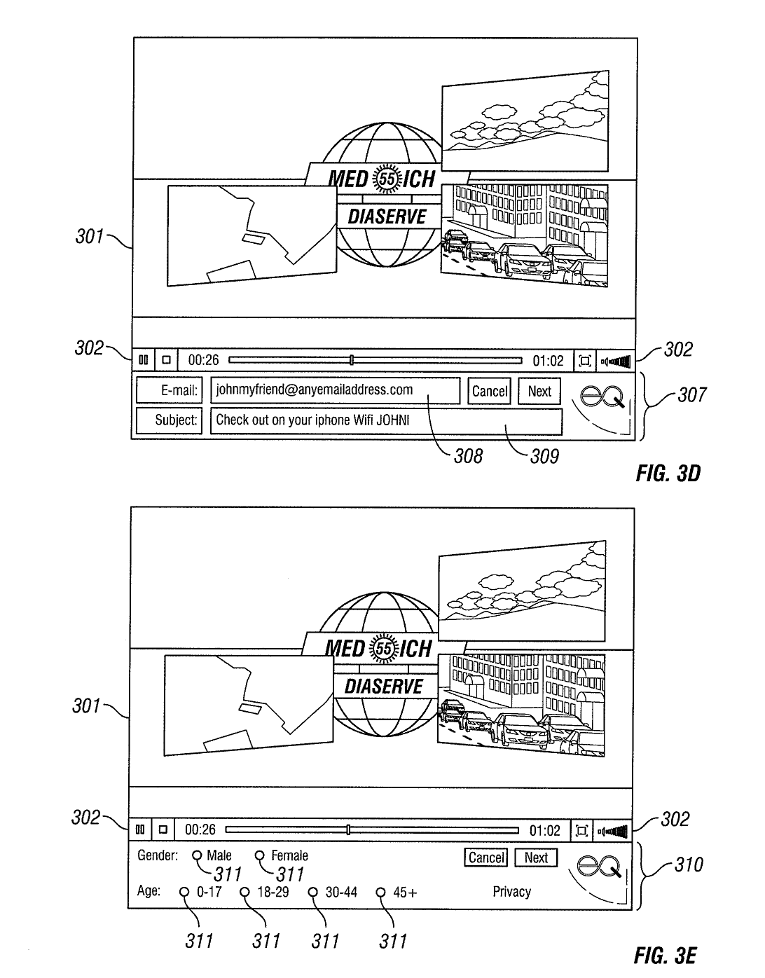

In the presently preferred embodiment of the invention, the content providers will enable their content media with a media delivery bar. FIG. 3A illustrates a basic flowchart 399 showing the steps for a content provider to follow for delivering their content with an integrated media delivery bar according to the invention. First, the content provider creates an account 398 with the system. Next, the content provider uploads one or more media assets 397 to the system. Next, the media assets are enabled with the media delivery bar 396. The content provider then configures demographic queries to be delivered to a user along with the content 395. The content provider then configures advertisement slots and preferences for the asset 394. Finally, the media asset is published 393 with a media delivery bar.

In the presently preferred embodiment of the invention, uploaded media assets are published with a media delivery bar. FIG. 3B illustrates an example of a video asset configured with a media delivery bar. FIG. 3B illustrates a video player 301, controls 302, and media delivery option submenu 304. As shown, the media delivery bar enables users to send the video asset to a variety of mobile devices including, but not limited to: a 3G Japanese mobile device, a 3G United States mobile device, an iPhone, an iPod, a Mac, and/or a PC running a Windows OS. While specific examples of media delivery options are given, it will be apparent to those with ordinary skill in the art, having the benefit of this disclosure, that any media device can be enabled to have media assets delivered thereto.

In some embodiments, content providers have the option to present demographic information queries to the users via the media delivery bar. For example, a content provider may upload a music video, enable the video with the media delivery bar, and provide interactive tools in the media delivery bar for a user to enter age, sex, and geographical location information.

In the presently preferred embodiment of the invention, the demographic information is obtained via the media delivery bar after the content consumer selects a desired format. FIGS. 3B through 3E illustrates a progression of queries presented to a content consumer. As discussed above, FIG. 3b illustrates the media delivery bar with a means for a content consumer to select a desired delivery format from among those presented in the media delivery option submenu 304. The users simply select the channel/device they want to send the current video on-screen to.

In some embodiments of the invention, after a device is selected from among those presented in the media delivery option submenu 304, a second delivery option sub-menu 305 comes up if more information about the channel is required, as shown in FIG. 3C. In some embodiments, a “help me choose” button 306 includes a link to a description of the sub-menu items, which is simply a web-page that can be updated from time to time by an administrator.

Upon specification of the device options, a delivery method submenu 307 is presented to the content consumer, as shown in FIG. 3D. In some embodiments, the delivery method submenu includes a field 308 to enter the intended recipients e-mail address. In some embodiments, a subject line 309 is included as well. The subject line 309 can be changed to whatever the user wants. Optionally, a default subject line message may be provided.

Finally, upon specification of the device method, a demographics submenu 310 is presented to the content consumer, as shown in FIG. 3E. The demographics submenu 310 includes checkboxes 311 for accepting answers to demographic questions. These questions are controlled by the demographics interface presented to a content provider upon uploading an asset, as explained above. The questions can be used to determine which advertisements, pre-rolls and external advertising exchange can feed into the content. Questions can be anything a content provider wants, such as “Gender”, “Age?” or even “Do you dye your hair? Yes or No”

Obtaining demographic information from the consumer of the content enables hyper-targeting of the advertisements, as explained below. In some embodiments of the invention, demographic information is shared between content providers to populate a more robust database. Content consumers will often be more than willing to offer demographic information in exchange for free delivery to their mobile device without the hassle of installing a plugin to support the native file type.

### Client Interface—Advertisement Provider Setup, Ad-Per-View

Advertisers will be drawn to this system because it will allow them to target content consumers who have previously answered demographics queries (explained above) that relate to the advertisers' products. Additionally, the Management Platform is very user friendly and automatically and optimally transcodes and reformats advertisements to run on any format. The system also offers a new level of tracking and new ad tracking metrics not previously available.

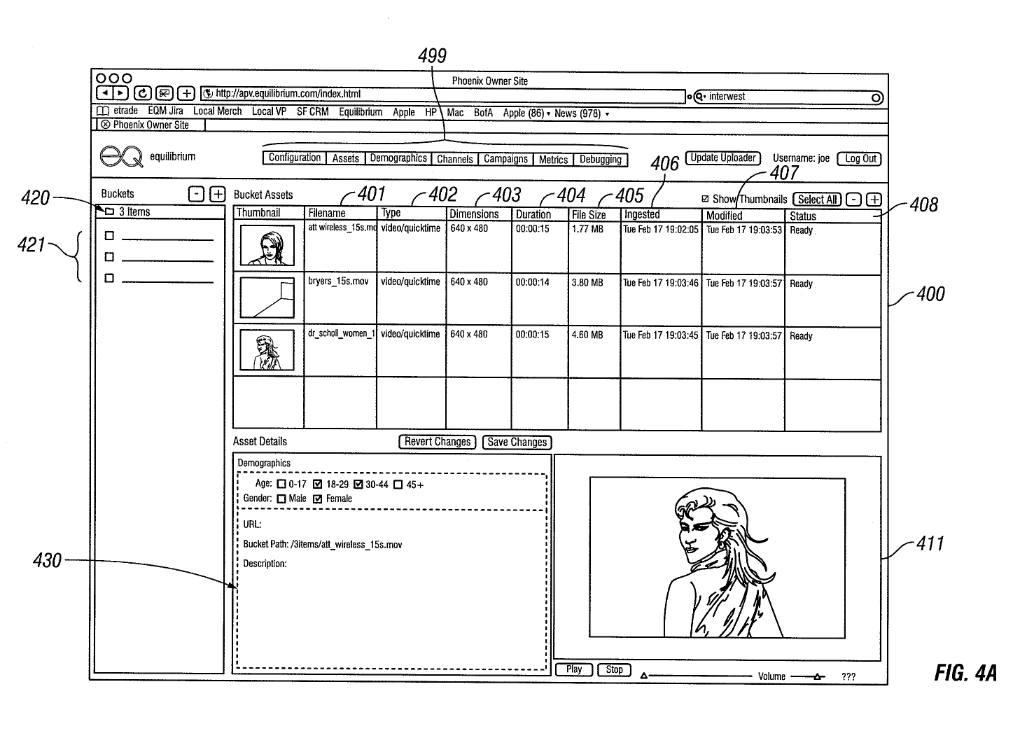

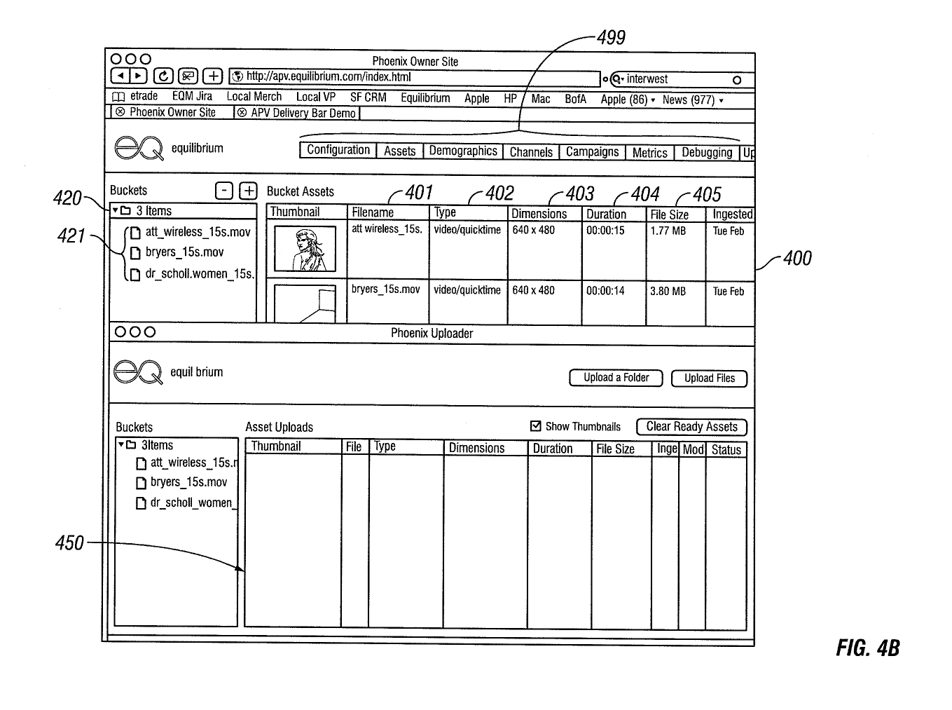

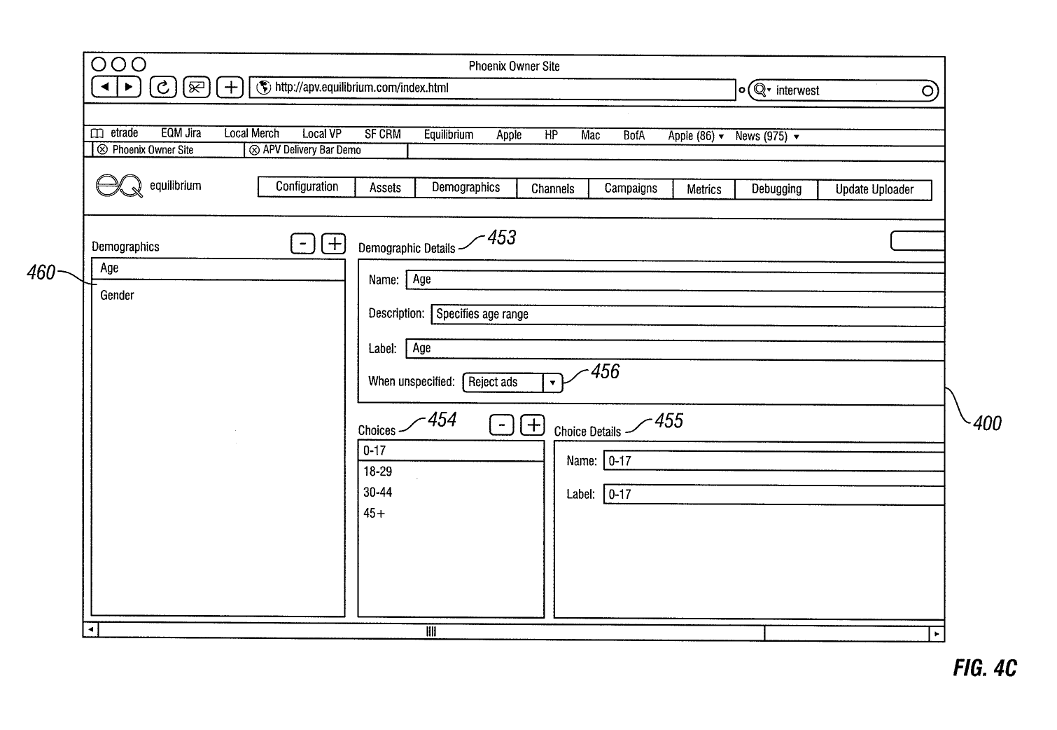

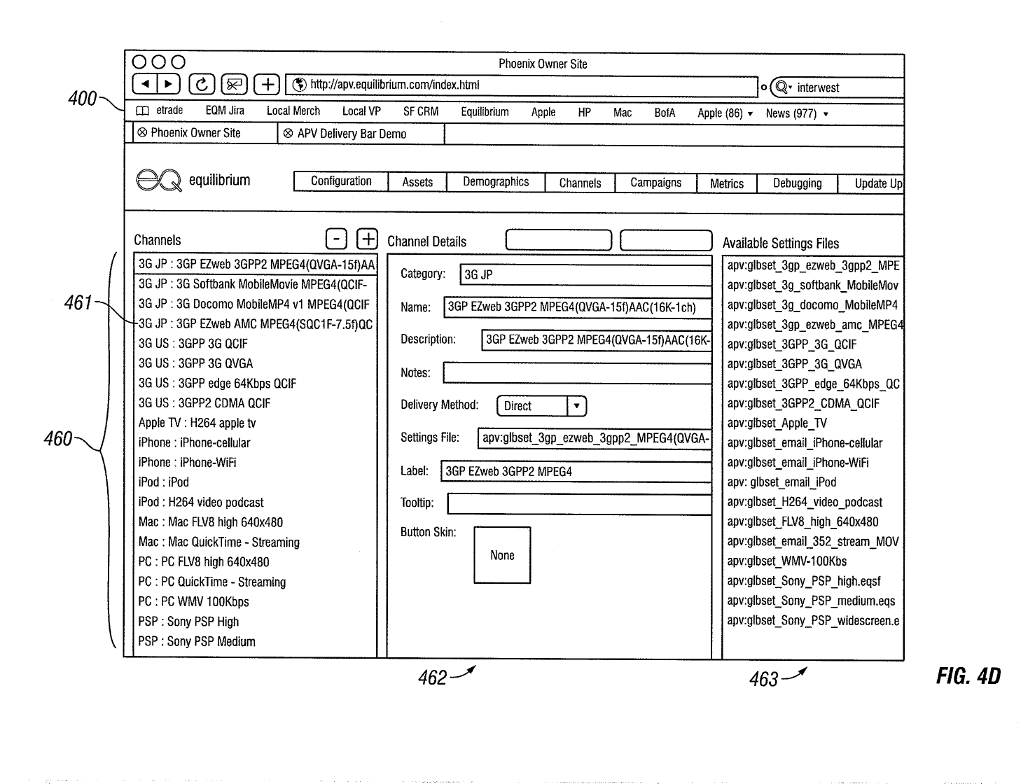

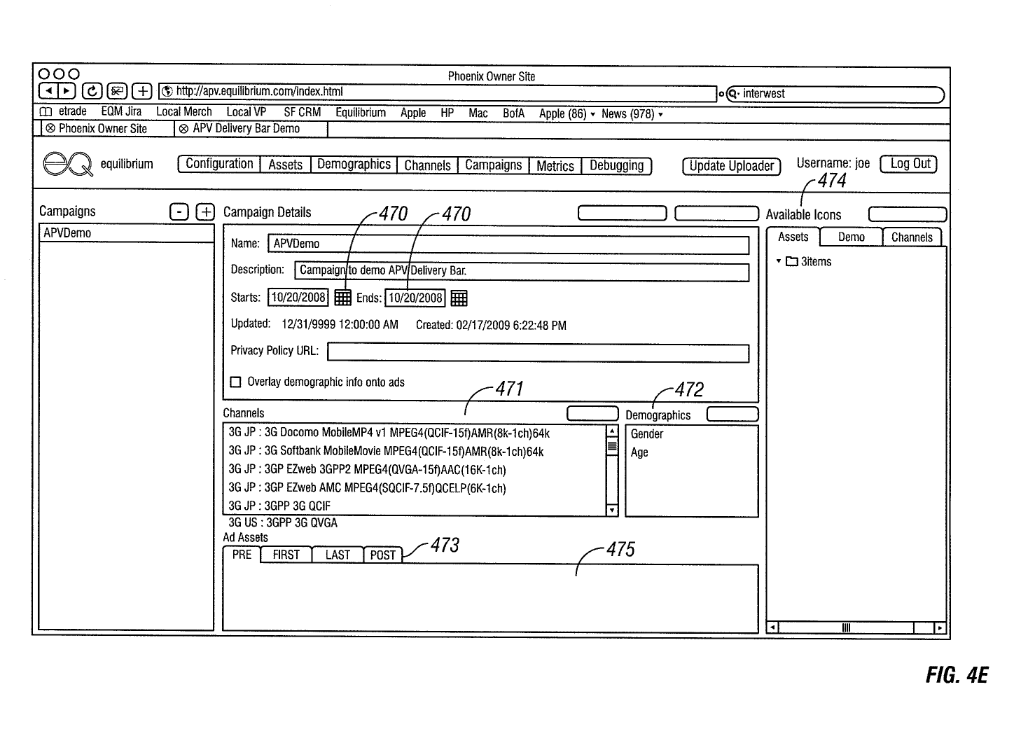

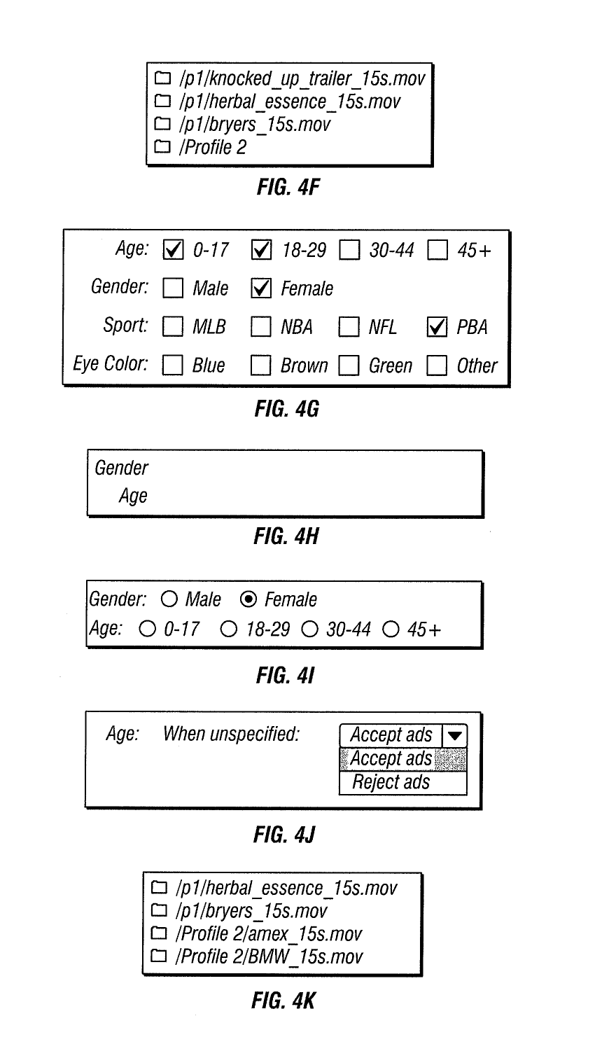

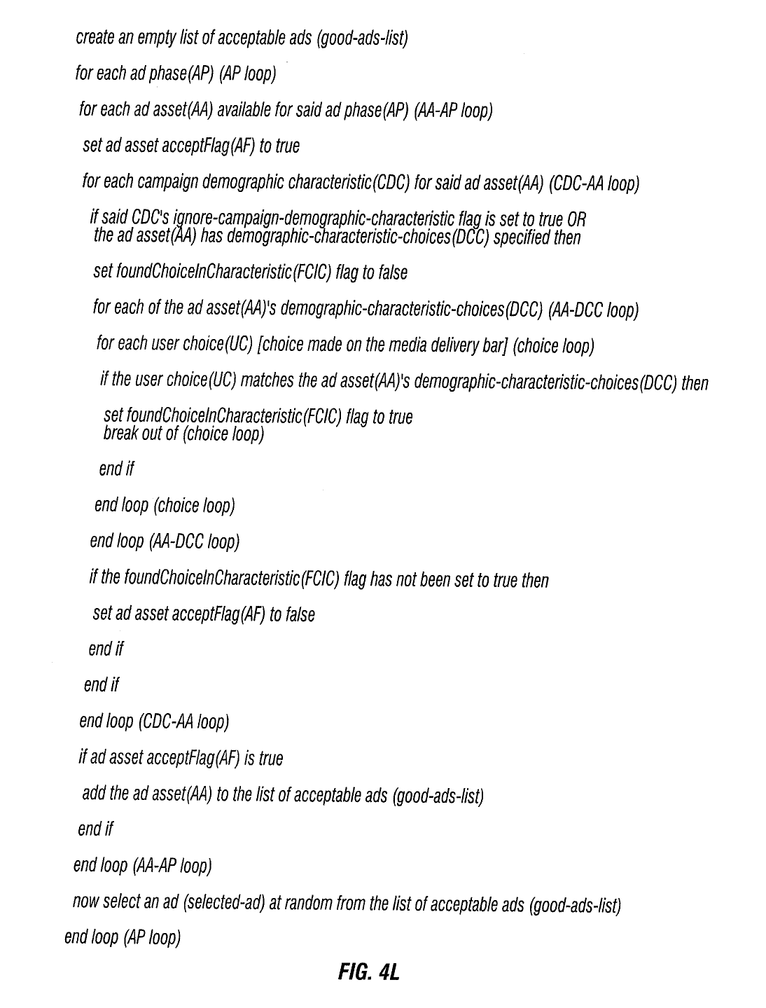

According to some embodiments of the invention, the system provides content advertisers with a hosted platform for uploading and configuring advertisement assets and for creating an entire advertisement campaign. FIGS. 4a-4e illustrates presently preferred embodiments of the invention where the hosted management platform comprises a hosted interactive website 400.

FIG. 4a illustrates a hosted interactive website 400 with a series of tabs 499 indicating various functions (i.e. “Configuration,” “Assets,” “Demographics,” “Channels,” “Campaigns,” “Metrics,” and “Debugging”) of the website 400. Each of the tabs 499 offers the user system functionality. For example, the “Configuration” tab allows a user to create an account, select a subscription plan, adjust default settings, etc.

FIG. 4A illustrates an embodiment of the website 400 showing the content and functionality of the “Assets” tab (as indicated by the darkened border) having an Asset Details field 430 according to some embodiments of the invention. The “Assets” tab presents the ingestion status of assets, presents thumbnails 410 of uploaded advertisements, presents basic metadata relating to the media including filename 401, type 402, dimensions 403, duration of the video (if applicable) 404, file size 405, data the file was ingested 406, data of the last modification 407, and an indication of whether the assets is ready for delivery 408. In some embodiments, types of indicated states of readiness include, but are not limited to “Uploading,” “Ingesting,” “Ready,” or “Error.”

Although specific types of metadata are explicitly set forth, it will be apparent to those with ordinary skill in the art, having the benefit of this disclosure, that this metadata, as well as other types of metadata, now known or later developed, can be included or excluded as required by the user or the host.

In some embodiments, when an asset is uploaded into the system, a proxy thumbnail 410, an original poster, and/or an .flv movie 411 for previewing the commercial are created using the media processing module. The original media is stored and is typically the only media asset used to generate the final output for delivery. For example, in the presently preferred embodiment, an original video advertisement asset uploaded to the platform is the highest possible quality video and is the only video stored. All other derivatives of this original video are automatically generated by the media processing module as required (as explained below). In some embodiments of the invention, one or more buckets 420 are used by the advertisers to organize their individual advertisement assets 421.

In some embodiments of the invention, the Assets tab of the website also presents a user with an “Asset Details” field 430 for displaying and editing demographic details concerning assets.

FIG. 4B illustrates an embodiment of the website 400 showing the content and functionality of the “Assets” tab (as indicated by the darkened border) having an Asset Upload field 450 according to some embodiments of the invention. According to these embodiments, the Assets tab of the website 400 provides the advertiser user with buttons 440, 445 for uploading advertising assets as a batch or individually and an Asset Upload field 450 for viewing the progress of the uploads. The batch upload button 440 enables batch uploading of commercials into the asset management area. In some embodiments, the button 440 triggers the installation of an Air application on the client which enables up to 8 gigabyte files to be uploaded, and enables dragging an entire hierarchy of files in a single or multiple folders into a directory Another option is to select a desired into which to upload and dragging it into the Asset Upload field 450.

FIG. 4C illustrates an embodiment of the website 400 showing the content and functionality of the “Demographics” tab (as indicated by the darkened border) according to some embodiments of the invention. The Demographics tab offers the users controls over to what type of audience they would like to offer their advertisements. The demographics editing enables unique questions to be created for structuring advertisement choices that are eventually returned from a user via the Media Delivery Bar. For example, a list of demographics 460 may include questions relating to Age and Gender. When the Age option is selected, a number of editable details 453, choices 454, and choice details 455 are presented to the advertiser user. The user can add or subtract choices and choice details. Additionally, an Accept/Reject Ad button 456 is configured to allow the user to specify whether advertisements will be delivered or withheld from a user who does not answer a demographics query presented to them via the Media Delivery Bar.

FIG. 4D illustrates an embodiment of the website 400 showing the content and functionality of the “Channels” tab (as indicated by the darkened border) according to some embodiments of the invention. The Channels tab allows a user to manage device channels and settings. As shown in FIG. 4D, a list 460 of device channels is presented in an interface frame 461. The user selects a listed device channel and is offered tools to configure Channel Details 462 and Settings 463. For example, a given device may allow WiFi traffic as well as cellular traffic. According to this example, both options are presented to a user in the list 460. In some embodiments of the invention, the channel used to transmit content limits the resolution of the media available for that delivery.

FIG. 4E illustrates an embodiment of the website 400 showing the content and functionality of the “Campaign” tab (as indicated by the darkened border) according to some embodiments of the invention. The Campaign tab allows a user to manage advertisement campaign details. The Campaign tab includes tools for managing start and end dates 470, tools to add/delete supported channels 471, tools for managing demographic information 472, and tools for managing advertisement slots 473. In some embodiments of the invention, a user merely has to drag assets from an “Available Items” frame 474 into an “Ad Slot” field 475 to include that particular advertisement asset in the ad campaign.

### Advertisement Selection Algorithm

When a user requests delivery of a video, the system inserts a number of ads into the media asset for delivery. The following describes the algorithm that the system uses to determine which advertisements are selected for insertion according to some embodiments of the invention. First, some terminology is defined.

Ad Asset. This is a media file containing advertising content that can be inserted into a payload media file to produce an output file suitable for delivery to an end user.

Demographic Characteristic. A personal attribute like age, or gender. A demographic characteristic can be associated with an end user, or with an ad asset. The system associates an additional property with a demographic characteristic that indicates whether ad assets can be matched to it when it is not specified by ether the end user, or the ad asset (explained below).

Demographic Choice. One of the possible values in a given demographic characteristic. For a characteristic like gender, the choices would be “male” and “female”.

Campaign. The publication of a given payload asset and its associated metadata. This includes lists of candidate ad assets, a set of demographic characteristics that are of interest (explained below).

Unspecified Characteristic. When an end user request delivery of an asset, they will be asked to volunteer demographic information about themselves (or another recipient of the delivery). If they decline to provide this information, we say that it is “unspecified” for the recipient. When ad assets are added to our system, the operator may associate demographic information with the added asset. If he does not, we say that it is “unspecified” for that asset.

The system accepts a number of inputs in the advertisement selection algorithm. FIGS. 4F through 4K illustrate an example of the user interface for selection of inputs by an advertisement provider while setting up a campaign and by a content consumer when requesting an asset via a media delivery bar.

A first input includes a set of candidate advertisement assets. FIG. 4F illustrates a schematic representation of a set of candidate advertisement assets including movie trailers, commercials, and a folder from which further candidate assets can be drawn from recursively.

The second input is demographic choices associated with each advertisement asset. After the advertisement provider selects various assets for a campaign, they individually associate each advertisement asset with demographic information. FIG. 4G illustrates a schematic representation of a selection interface for associating demographic choices to individual advertisement assets. Any number of choices may be selected for an ad asset's demographic characteristic. Note that no choices are selected in the last row below. This characteristic is said to be “unspecified”.

The third input is a set of demographic characteristics associated with the campaign as a whole. After each asset is assigned demographic characteristics, the campaign as a whole can specify one or more demographic requirements. FIG. 4H illustrates a schematic representation of a whole campaign demographic selection interface according to some embodiments of the invention.

The fourth input into the advertisement selection algorithm includes demographic information specified by a content consumer upon requesting delivery of an asset using a media delivery bar, as explained above. FIG. 4I illustrates a schematic representation of a demographic selection interface shown to a content consumer in a media delivery bar according to some embodiments of the invention. As shown in FIG. 4I, the user has not selected an age. Accordingly, this characteristic is said to be “unspecified”.

The fifth input into the advertisement selection algorithm is specified by an advertisement provider when establishing a campaign. The fifth input comprises a property of each demographic characteristic which defines how the selection algorithm will behave when that characteristic is unspecified by an asset, or by the requesting user. FIG. 4J illustrates schematic representation of an interface for an advertisement provider to indicate whether to accept or reject advertisements when a demographic characteristic is unspecified.

The advertisement selection algorithm accepts the inputs and resolves what advertisements to deliver along with an asset. These ads are inserted into the output file that is delivered to the end user. FIG. 4K illustrates a schematic representation of an advertisement asset list output by the advertisement selection algorithm according to some embodiments of the invention. Given the ad asset candidate list shown in FIG. 4F, we might end up with, for example, two of the three top-level ad assets, and two ad assets from within the “Profile 2” candidate folder.

When an end user requests a delivery from the Ad-Per-View system it responds by collecting a list of ad assets whose demographic information, best matches the demographic information provided by the end user, taking into account which demographics are of interest to the campaign, and which characteristics must be specified, and inserting these ads into the payload media to produce the output. FIG. 4L illustrates an embodiment of an advertisement selection algorithm represented in psuedocode.

### On-Demand Media Processing Engine

Central to the system described above is an on-demand media processing engine that automates the production of images, animations and video. In some embodiments, the media processing engine is integrated into the system architecture as explained above. In some other embodiments, the media processing engine comprises a standalone peripheral device.

The media processing engine enables end-to-end ingestion and delivery of media assets to and from any device/platform. Examples of typical destinations include IP television, broadcast television, video on-demand, web streaming, computer downloads, media players, cellular devices, personal digital assistants, smart-phones and web pages. The engine also allows a user to auto-assemble programs on the fly as they are deployed in addition to adding advertisements.

As explained above, the method for delivering composite content begins with a content consumer making a request for media for a particular device. For example, a content provider may have previously enabled a video of a comedy skit enabled with a media delivery bar, as explained above. The content provider posts the enabled video on a website. The content consumer then finds the enabled video and requests that the video be sent to his video-enabled cellular phone so he may view the video on the go. In the presently preferred embodiment of the invention, the content consumer enters personal demographic information along with this request.

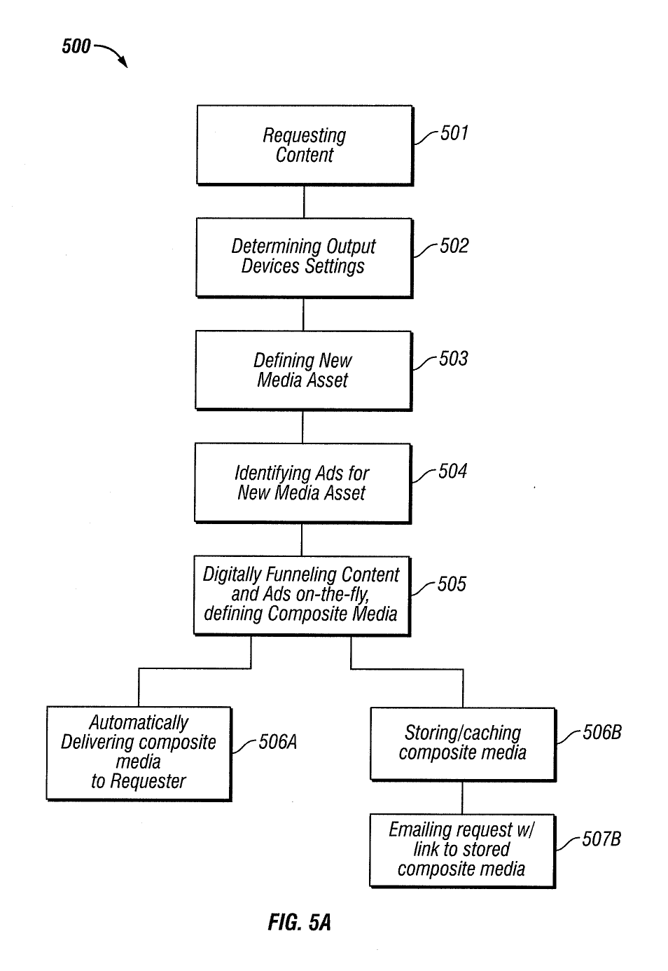

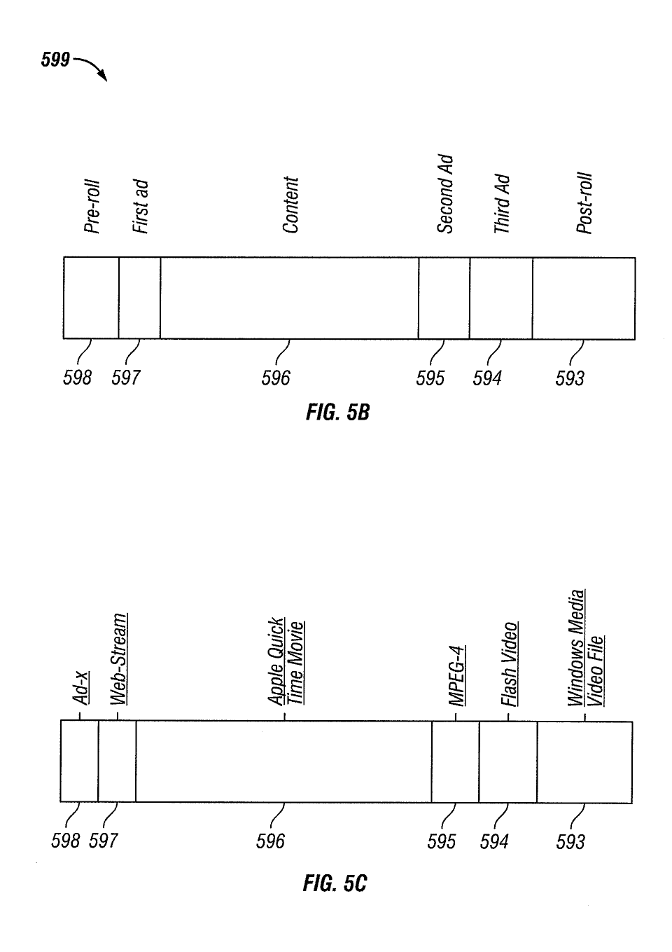

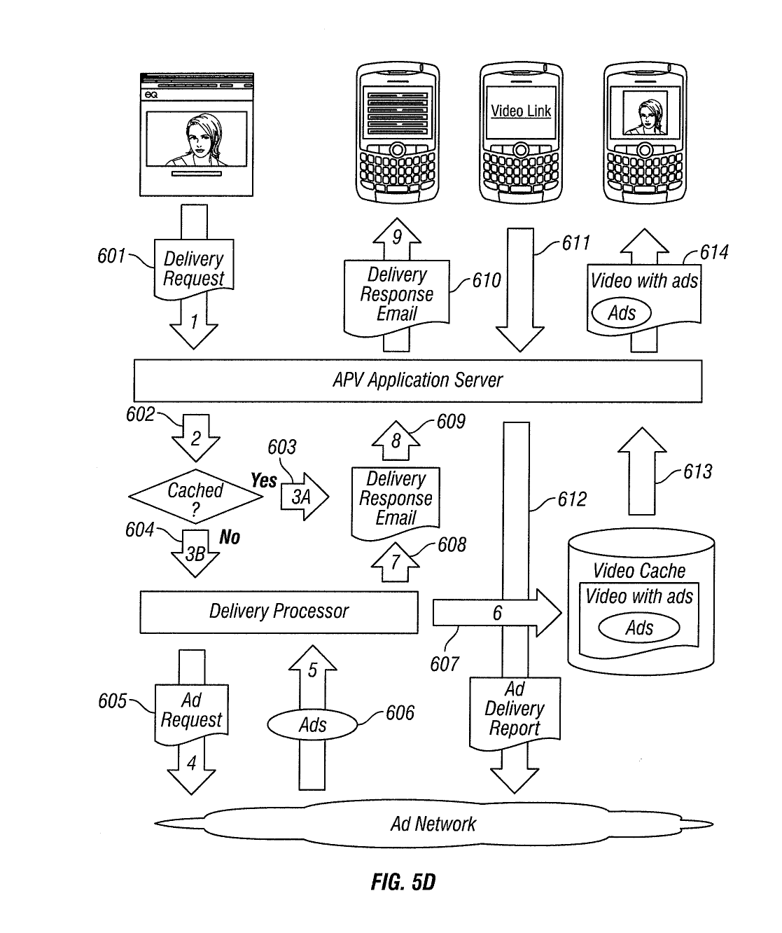

The request made by a content consumer begins a process of on-demand media processing. FIG. 5A illustrates a schematic representation of an exemplary process 500 defined by a request for content according to some embodiments of the present invention. The process 500 begins with a content consumer requesting content 501. Preferably, the request is accompanied by demographic information. In some embodiments, the demographic information is supplied explicitly through a media bar, as explained above. In some other embodiments, the demographic information is supplied from a secondary source. For example, the information may be stored by the content provider or supplied by a third party. In some other embodiments of the invention, the demographic information is predicted contextually. For example, when a request for content is made from a website that only delivers children's entertainment content, it is likely that the audience viewing the content is comprised primarily of children.

The process 500 continues by determining the requested output device's settings 502. For example, if a digital video is requested, the process 500 determines the video output device's video playback speed requirements, screen size and resolutions limits. Based on the determined settings, the process then defines output requirements for the new composite media asset 503. In some embodiments of the invention, defining the new composite media asset includes referencing the content provider's desired account settings to determine how the content provider defined its preferences for location of advertisement slots during the setup phase.

FIG. 5B illustrates a representation of an example of a new composite media definition 599 according to some embodiments of the invention. The media definition 599 identifies the content 596 prefaced by a pre-roll advertisement slot 598 and a first advertisement slot 597. Similarly, the content 596 is followed by a second advertisement slot 595, a third advertisement slot 594, and a post roll slot 593.

In some embodiments of the invention, the content 596 is segmented for additional advertisement insertion. For example, content 596 having a long run time may be segmented every few minutes for the purpose of serving an advertisement. According to these embodiments, scene detection algorithms and audio pause detection means are employed to detect appropriate times to segment the long-form media.

Referring again to FIG. 5A, after defining the new composite media 503, the process 500 continues with identifying advertisements for the new composite media definition. In some embodiments of the invention, the advertisements are identified by cross referencing the gathered demographic information with the advertisement provider's advertisement campaigns. For example, as shown in FIG. 4A, an advertisement provider sets up its advertisement campaign by placing advertisement files 421 into one or more folders 420 and the folders 420 which are associated with demographic information 430. Accordingly, when a request is processed, advertisement files 421 are taken from folders 420 with the same associated demographic information as that specified by the requester. In some embodiments, the files 421 are randomly chosen from the 420 folders. In some other embodiments, the files 421 are selected sequentially, or in some other logical order.

Typically, the identified advertisements and the content media will not be perfectly homogeneous. For example, the advertisements and the content will likely have different file types, frame rates, resolutions, audio types, etc. FIG. 5C illustrates an example of a composite media definition 599 after advertisements have been selected for the ad slots 593, 594, 595, 597, and 598, wherein the advertisements comprise diverse audio/video file formats.

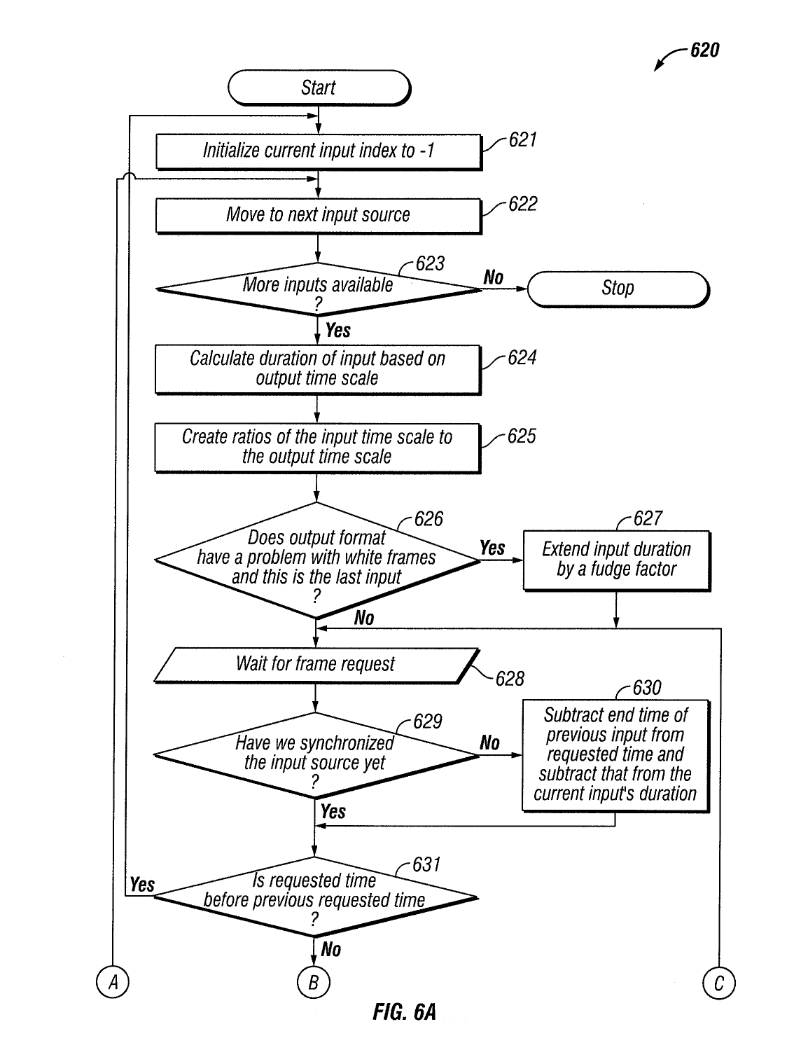

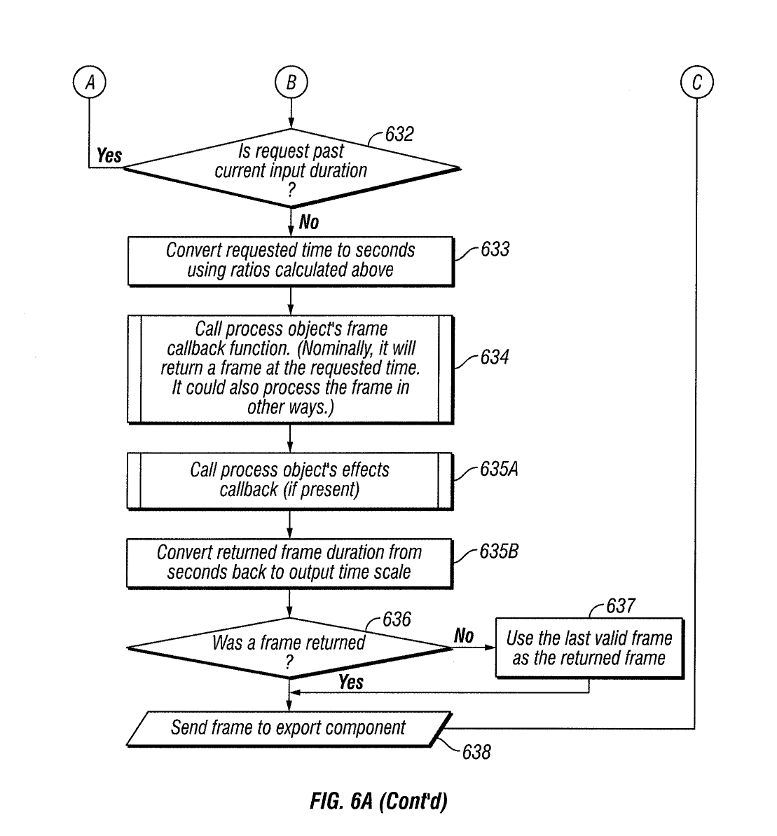

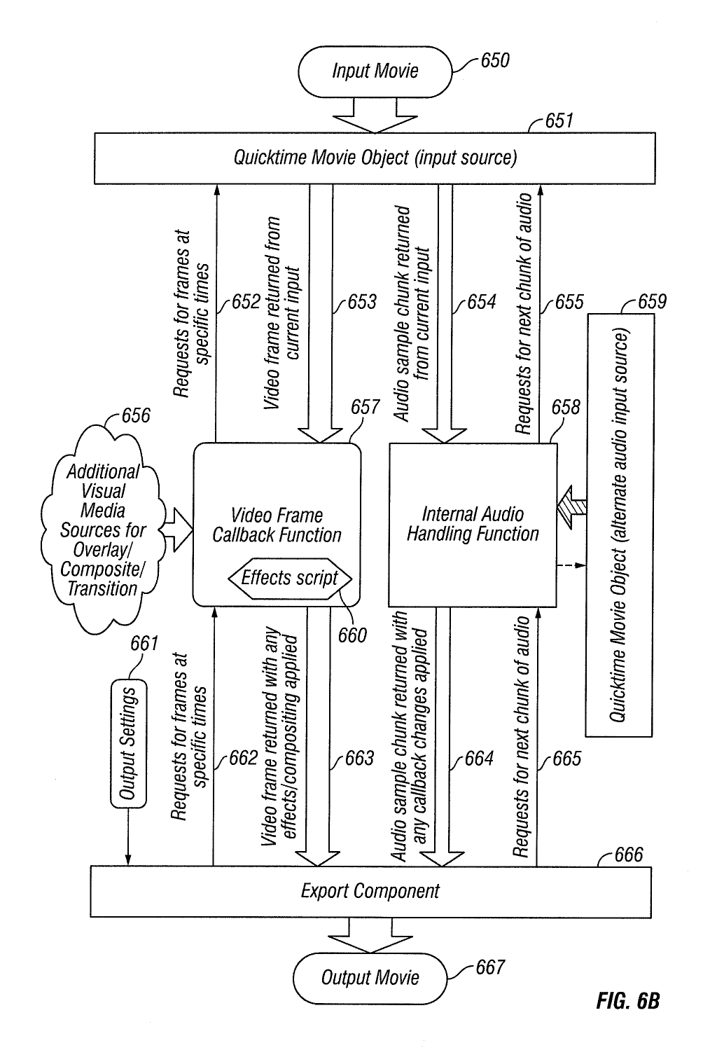

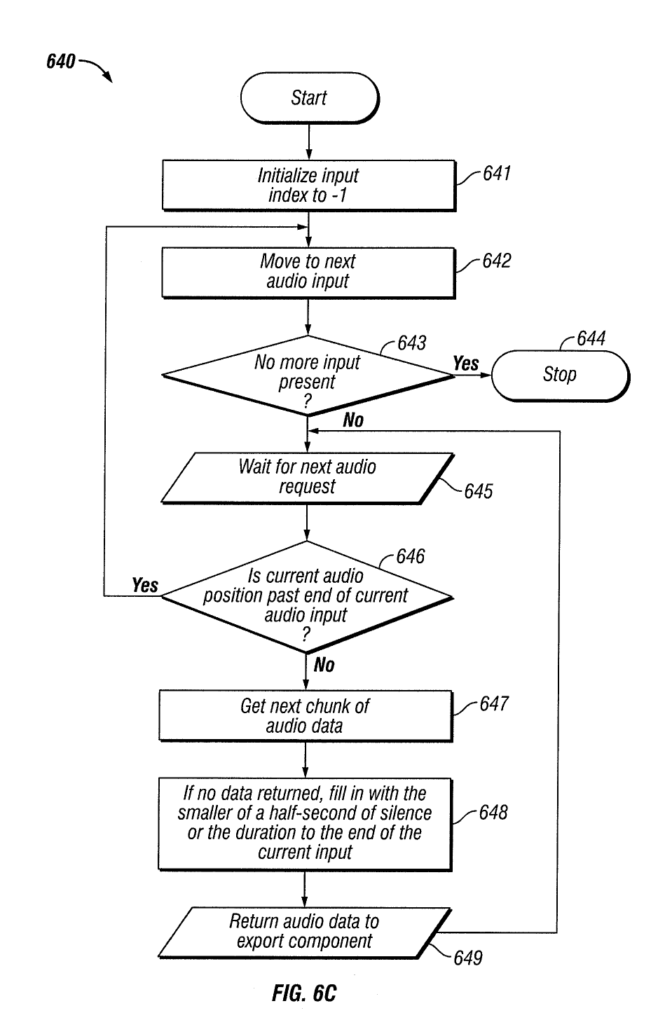

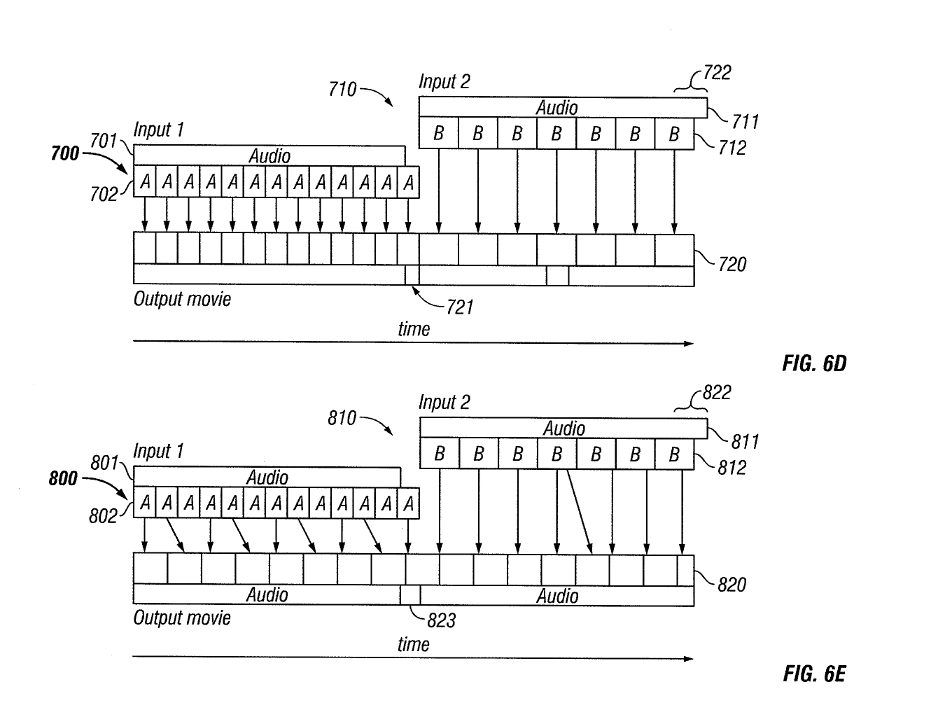

Referring again to FIG. 5A, once the advertisement assets are identified, the process 500 digitally funnels 505 the content and advertisements on-the-fly to create the new composite media asset. The process of digital funneling is explained more fully below when discussing FIGS. 6A through 6F. The process of digital funneling 505 results in a new media asset in the user defined format with the appropriate settings for playback on the chosen output device.

The process 500 continues after digital funneling 505 by delivering the new composite media. In some embodiments, the process 500 automatically delivers the composite media 506A to the requesting content consumer. In some other embodiments, the composite media is stored 506B before delivery. According to these embodiments, a requesting content consumer is sent an email 507B with a hyperlink, linking the user to the stored media. In some embodiments of the invention, the hyperlink may be accessed for viewing the composite media from anywhere including a network-based browser, portable devices, digital video recorders, and other content portals, now known or later developed.

FIG. 5D illustrates an alternative representation of an alternative method 600 for delivering digital media according to some embodiments of the invention. The method 600 begins as a user makes a request 601 to the Ad Per View system asking that a composite video be prepared and delivered to a list of email addresses. During the request 601 process, a set of demographics concerning the target user is collected. Next, the Ad Per View system determines 602 if an appropriate version of the video has already been generated that contains ads targeted to that set of demographics based on the source video and the user's demographics. Next, if an appropriate derivative video has already been generated, then the system skips 603 the generation process and proceeds directly to the email sending phase (step 608). On the other hand, if no appropriate derivative video yet exists, then the request is sent 604 to the Delivery Processor to cause an appropriate video to be generated.

Next, the Delivery Processor generates an Ad Request 605. This request includes all available information about the user that requested this video, including the kind of device that is targeted, the demographics collected for that user, and the target email address list. This request is submitted to the Ad Network. The Ad Network responds 606 by sending back a set of ads targeted to the requesting user. The response may not itself contain the ads, but may rather contain references to those ads to allow them to be requested via additional requests. The Delivery Processor then produces 608 a derivative video containing the primary content that the user requested as well as the ads that target that user. It places this derivative video in the Video Cache.

Next, the Delivery Processor notifies 609 the main Ad Per View system that the requested video has been generated and is ready to be viewed. The Ad Per View system then sends 610 an email to each of the destination email addresses specified in the user's request notifying the recipients that the requested video is now available. This email includes a URL link that can be used to access the requested video.

Upon completion of the email delivery of the URL link, a user views 611 the email notifying him/her that the requested video is ready to be viewed. That video contains a URL link. The user clicks on the URL link. This causes a request to be made to the Ad Per View system asking for the video. Next, the Ad Per View system notifies 612 the Ad Network that a set of ads are being sent to the target user to be viewed as part of the requested video. The Ad Per View system reads 613 the requested video from the Video Cache. Finally, the Ad Per View system delivers 614 the requested video to the target device for viewing.

### Digital Funneling

The process of digital funneling consists of obtaining a plurality of media files and automatically assembling the files according to a user defined workflow. As explained above, the process ingests various media content and advertisements, each of which may be ingested as unique or diverse audio formats and video formats. A number of variables may differ between the formats including bit depth, audio rate, scaling, and bitrate, among others. Most significantly, the various video formats may each have different video frame rates.

The media processing engine converts the media files in various video formats to the new composite media file by converting the media files, from their native timescale units to a standardized timescale. In some embodiments of the invention, the standardized timescale is in seconds; however, a person with ordinary skill in the art will understand that any timescale can be used to achieve the novel aspects of the invention. Using this conversion, any video file can be synchronized to an internal clock. Accordingly, after the conversion, it does not matter what the native frame rate was, so long as the processing engine can tell what frame is being presented at a given time being kept by the internal clock. For example, 5.345 seconds (internal clock time) into a first movie file with a frame rate of 12 frames per second (FPS) is the equivalent of 5.345 seconds into a second movie file with a frame rate of 29.97 FPS. For either of these formats, the processing engine pulls whatever frame corresponds with a chosen internal clock timestamp. All total durations, frame durations, and seek positions are converted from the output movie file's timescale to seconds and then to the current input movie's timescale and (for seeks) to its local time.

In some embodiments, the native media format requires a preprocessing step to normalize scale of the media file. According to these embodiments, the media processing engine recognizes that the ingested file format does not fit the output media dimensions. Accordingly, the engine scales the image on-the-fly to match that of the output movie and/or other inputs.

In some embodiments, the engine converts the file into an intermediate movie file of the appropriate dimensions before making the conversion from native timescale to internal clock time. Intermediate movies are typically only required to work around known export issues with certain Quicktime formats, e.g, iPhone, iPod, AppleTV, 3g, among others.

FIG. 6A illustrates a schematic representation of an on-the-fly video export process used in digital funneling according to some embodiments of the invention. The process 620 begins with initializing 621 an input number index. The process then moves to the next input 622 and determines 623 whether any more inputs are present. If so, the engine calculates 624 the duration of the input media file based on the desired output time scale. The engine then creates a ratio 625 of the media file input time to the output time scale.

The process 620 continues by determining 626 whether the current input is the last input, and if so, whether there is a problem with white frames. If so, the engine applies a correction factor 627 and proceeds. If not, the process 620 continues frame requests.

The media processing engine waits 628 for frame requests and when a frame is passed, determines 629 whether the input source has been synchronized from its native timescale. If synchronization is required, the engine subtracts the end time of the previous input from the requested time and then subtracts that from duration of the current inputs 630. The engine then determines 631 whether the newly requested time is prior to the previously requested input time. If so, the process reverts to initialing the input 621 and proceeds accordingly. If not, the media processing engine determines 632 if the input source request time is past the current input duration, and if so, reverts to moving to a next input source 622.

If the input source is properly positioned (as determined in steps 631 and 632), the media processing engine converts 633 the requested time to an internally synchronized time (in seconds) using the ratios calculated in step 625. Next, the media processing engine call processes the object's frame call back function 634 to return a frame. In some embodiments, the processing engine performs other frame processing at this point (scaling resolution, padding edges, etc.) Next, the processing engine processes 635 an object's effects (fade in/out, panning, zooming, etc.), if any.

Finally, the process 620 converts 635 a returned frame duration from the internal time clock time (in seconds) to the output timescale and determines 636 if a frame is returned. If a frame is returned, it is sent 638 to the export component and used in the composite media file. If an actual frame is not returned, the media processing engine uses 637 the last valid frame as the returned frame and exports 638 that frame to the export component. The process 620 reiterates with pulling new frames until the composite media file is built as defined by the request for media.

In some embodiments of the invention, particular processing steps are known in advance for known output formats. In particular, it is desirable to know certain required steps for initializing certain filetypes for exporting the media. For example, when the media processing engine receives instructions to process a Quicktime Movie, it can reference a set of known rules relating to various processing steps required for processing.

Table 1 summarizes a set of particular processing steps for initializing media files for export.

TABLE 1

| Exporter | Use | Requires V1 | Property call- | Property | Pad video | All audio | Intermediate | Intermediate | Intermediate | No |
|---|---|---|---|---|---|---|---|---|---|---|
| Component | Integer | QuickTime | back requires | callback | track to | sample rates | is precom- | movie is | movie is | inter- |
| Name/ | Audio | SoundDe- | input source | should never | prevent | must be set | pressed then | losslessly | flattened | mediate |
| Codec Name | Samples | scription | information | return error | white frames | to 48 KHz | finalized | compressed | for final | movie |
| Quicktime | Y | | | | | | | | Y | |
| Movie | | | | | | | | | | |
| AVI | Y | Y | | Y | | | | | | Y |
| AIFF | Y | Y | | Y | | | | | | Y |
| WAV | Y | Y | | Y | | | | | | Y |
| AU | Y | Y | | Y | | | | | | Y |
| Windows | Y | | | | Y | | | | | Y |
| Media | | | | | | | | | | |
| (Flip4Mac) | | | | | | | | | | |
| Windows | Y | | | | | | | | | Y |
| Media | | | | | | | | | | |
| (Native) | | | | | | | | | | |
| Adobe Flash | | Y | Y | | | | | | | Y |
| Video | | | | | | | | | | |
| On2 | | | | | | | | Y | | |
| Technologies | | | | | | | | | | |
| Flash Video | | | | | | | | | | |
| iPod | | | | | | | | Y | | |
| iPhone | | | | | | | | Y | | |
| iPhone | | | | | | | | Y | | |
| Cellular | | | | | | | | | | |
| Apple TV | | | | | | | | Y | | |
| MP4 | | | | | | | Y | | | |
| PixelTools | Y | Y | | | | Y | Y | | | |
| MPEG-2 | | | | | | | | | | |
| Anything | | | | | | | | Y | | |
| using | | | | | | | | | | |
| QCELP | | | | | | | | | | |
| audio | | | | | | | | | | |

Likewise, Table 2 summarizes a set of particular processing steps for input special handling.

TABLE 2

| | Use Integer | Requires V1 | Property callback | Property callback | Pad video track | All audio sample |
|---|---|---|---|---|---|---|
| | Audio | QuickTime | requires input | should never | to prevent | rates must be |
| Input Special Handling | Samples | SoundDescription | source information | return error | white frames | set to 48 KHz |
| Windows Media (Native) | Y | | | | | |
| ffmpeg handles inputs | Y | | | | | |

Following the previous example, when the media processing engine encounters a Quicktime Movie, it can reference the set of rules contained in Table 1 to determine that processing requires that the engine use integer audio samples and that an intermediate movie be processed and flattened for final export.

Digital funneling various input media files into a composite new media file also involves synchronizing the audio signals associated with the various input files. For example, a new composite media definition may include input files with different audio file types. The media processing engine handles this situation by determining the audio sampling rate for all of the various inputs, determining the highest common denominator and converting all the inputs to the highest sampling rate.

FIG. 6B illustrates an example of digital audio/video funneling according to some embodiments of the invention. As explained above, the invention ingests a plurality of input movie files 650, 656 and exports an output movie 667. In this example, the input movie 650 comprises a Quicktime Movie 651. The processing engine contains a video processing node 657 and an audio processing node 658. The video processing node 657 includes a video frame call back function (described above) and an effects 660 adding function. Additionally, an export component 666 contains a definition of the requested new composite media, defined by a user. The output settings 661 are preferably saved.

The export component 666 is timed on an internal clock and makes a request 662 for the frames of a given input at specific time. The video processing node 657 makes a request 652 to the Quicktime Movie input for the frames that synchronize with specific times on the internal clock. In response to these requests, the input provides video frames 653. The video processing node 657 adds any effects to the frames that are applicable, and then returns 663 the video frames to the export component 666. The process of sending frame requests and returning frames from an input file based on an internal clock is reiterated, as described in FIG. 6A.

Additionally, the audio processing node 658 contemporaneously receives requests from the export component 666 for the audio chunk that corresponds in time with the current frames. The audio processing node 658 requests audio input 655, ingests audio inputs 654, and returns the appropriate audio output 664 to the export component.

FIG. 6C illustrates a schematic representation of a on-the-fly audio synchronization process 640 used together with the video processing for digital funneling according to some embodiments of the invention. The process 640 begins with initializing a file input index parameter 641. After initialization, the process 640 moves 642 to a first (or the next) audio input. If the engine determines 643 that there are no more audio inputs present, the process 640 ends 644.

Alternatively, if more audio inputs are found, then the process 640 waits 645 for the next audio input and, when received, determines 646 whether it is in the appropriate position. If not, the process returns to step 643 and move to another audio file. If the audio request is in the appropriate position, the process 640 locates 647 a chunk of the audio signal to be output as the exported audio signal 649. If audio is present for a given time position, the process 640 fills in the output with the smaller of a half-second of silence, or the duration to the end of the current input. The process 640 concludes with sending output audio data to an export component 649.

FIGS. 6D and 6E illustrate examples of assembling a user-defined composite media file from a plurality of input files. In FIGS. 6D and 6E, frame rate is represented by the width of frames A and B, in relation to the horizontal time axis. FIG. 6D illustrates a first example including a first input 700 and a second input 710. The first input 700 includes an audio component 701 and a video component 702. The video component 702 includes frames A. Likewise, the second input 710 includes an audio component 711 and a video component 712. The video component 712 for the second input includes frames B.

According to this example, the user-defined output movie setting does not include a specified frame rate. Therefore, the media processing engine can simply concatenate the two inputs without having to worry about sampling up or down to a specific frame rate. The output movie 720 simply uses the frames A and frames B in sequential order, as indicated by the arrows.

A potential complication exists when the audio component 701 of the first input does not exactly match the duration of the video component 702 first input, or when the video component 712 of the second input does not match the duration of the audio component 711 of the second input, as shown in FIG. 6D.

According to some embodiments of the invention, interior audio track splices 721, for example, have silence inserted to match the longer video track. Likewise, interior video track splices (not shown) may be compensated for by increasing the duration of the last frame to match a longer audio track. Similarly, exterior audio or video tracks 722 may be truncated or extended to accommodate longer audio/video counterparts.

FIG. 6E illustrates an example of a user-defined output movie with a specific frame rate including a first input 800 and a second input 810. The first input 800 includes an audio component 801 and a video component 802. The video component 802 includes frames A at a first frame rate. Likewise, the second input 810 includes an audio component 811 and a video component 812. The video component 812 for the second input includes frames B, at a second frame rate.

Because the output movie's 820 frame rate is lower than that of the first input 800, certain frames (those without an arrow) are dropped from the resulting output movie 820. The media processing engine applies an algorithm that takes the requested start time of the output and looks at which frame that requested time falls in between the input movie's corresponding start time and end time. According to FIG. 6E, the requested output times correspond with the left edge of each frame box, and the end time of each frame is by each box's right edge.

Similarly, because the output movie's 820 frame rate is higher than the second input's 820 frame rate, certain frames are duplicated, as indicated by frames having multiple arrows. The frame to duplicate is based on where the requested output frame's start time falls between the corresponding input movie frame's start time and its end time.

Because the output movie 820 specifies a frame rate, the last frame in each input will take on the duration of the output frame rate. The frame is not truncated to the end of the input movie, and the audio is not extended. However, the audio is still extended with silence 823 so it at least matches the length of the first input 800 video component 802. The silence 823 is not noticeable since the start of the next audio input (audio component 811) overlays the previous input by a mere fraction of a second. Similarly, exterior audio/or video tracks 822 may be truncated or extended to accommodate longer audio/video counterparts.

Another part of the media delivery system is a monetization subsystem that is driven by effective tracking of ad campaigns.

### Tracking Advertisement Effectiveness

As explained above, the system may include a monetization subsystem. In some embodiments of the invention, the monetization subsystem reports monetization data to the advertisement provider and/or the content provider. In some embodiments of the invention, the media system is configured with a graphical user interface (GUI) to report information to a user. Two examples of reporting include: measuring the effectiveness of a content owner or a content rights owner to obtain advertisement revenue for their content; and tracking the effectiveness of an advertiser's campaign.

For publishers, content owners and content rights owners, the system tracks effectiveness of their ads winning highest-value from sponsors. Likewise, for advertisement agencies and for individual advertisers, the system tracks effectiveness of their spending on ad campaigns and/or tracks effectiveness, conversion rates, and popularity of specific ads against others within given product categories, regional markets, and/or viewer demographics.

In the some embodiments of the invention, the system is configured to track the effectiveness of the advertisements placed into media using traditional metrics, as well as newly developed advertisement metrics. Below is a list of various tracking tools, metrics and reporting techniques which can be used within the system according to various embodiments of the invention. It will be readily apparent to those having ordinary skill in the art with the benefit of the disclosure that the invention is equally applicable for use with all metrics, now known or later developed.

Cost per thousand impressions (CPM). This tracking and monetization recording technique charges a flat fee for every one thousand page impressions. For example, VideoEgg's rate of $12/thousand is considered very competitive. Note: the old print-ad notion of an “impression” on a reader has taken on different meanings with digital video ads.

Cost per click (CPC). A cost per click scheme provides a payment every time an advertisement is clicked. Generally used to measure effectiveness of Web-page banner ads, but has become less important, since more specific viewer interactions can now be tracked. Also vulnerable to widespread click fraud.

Cost per action (CPA). Viewer clicks through to specific sections of advertiser's e-commerce site. According to this pricing model, an advertiser pays for each particular action by a user.

Cost per conversion (CPCV). Considered more important than cost-per-click. Measures effectiveness of ad's ability to persuade viewer to click through and arrive at specific section of Web landing page, such as an online product ordering form.

“View-through” Metrics. New tracking methods tracking actions such as Mutes, pauses, average view times, and full-screen views.

Tracking Video Plays. Measures popularity of ad relative to other ads, by product category and viewer demographics

Tracking Video Completes. Measures attractiveness, or “resonance” of ad with viewers

Tracking Video View Time. Measures the percent of each ad watched by each viewer. In some embodiments the system will display a histogram showing view-time above a minimum threshold (e.g., 25%) for counting as an individual ad “impression.”

Tracking Expansions. Indicates viewer interest.

Tracking Interactions. Counts clicks on links to offers.

Tracking Forwarding. Counts the number of times a viewer emails an ad to someone else (measures an ad's “viralness”).

Tracking Abandonment. Counts the number of clicks on each individual exit link within an ad.

Other Reporting. In some embodiments, the system is configured to track specific custom “creative” metrics, such as games played, coupons downloaded, and special offers accepted. In some embodiments, the system is configured to provide brand safety information for advertisers and positive confirmation that their ads ran only in conjunction with appropriate content.

The disclosed system provides content owners a quick and easy method to insert relevant advertising via their own inventory or through third party partners, and deliver that content to any device without having to manage any of this infrastructure on their own, or manage all the derivative assets to deliver their personalized streaming or downloadable video content. Additionally, the system can enable hyper-targeted advertising insertion so that advertisers will pay the most to present a sponsorship, call to action, or other type of advertising spot at any particular moment, while simultaneously enabling a deliver-anywhere clean user experience.

Although the invention has been described in detail with reference to particular preferred embodiments, persons possessing ordinary skill in the art to which this invention pertains will appreciate that various modifications and enhancements may be made without departing from the spirit and scope of the claims that follow.

1. A system for automatically assembling and delivering composite media comprising:
a processor;
a memory;
a network interface;
an content ingestor module for ingesting original content and advertisement content;
a browser-based advertiser access point for creating an advertisement campaign, wherein the providers of advertisement content specify campaign details comprising target demographics for their advertisement content, thus defining targeted advertisement content;
an integration module for integrating interactive tools into the original content, and creating an original asset with a media delivery tools, wherein the media delivery tools accept information from an end-user;
a browser-based end-user access point for providing access to the original asset with a media delivery tools, wherein the end-user requests delivery of composite media through entry of media delivery options and demographic information through the media delivery bar, wherein the media delivery options define the requirements for composite media;
a media processing module including:
an edit decision module for defining a composite media asset including at least one piece of original content and at least one piece of targeted advertisement content, wherein the demographic information defining the targeted advertisement content matches the user entered demographic information; and
a digital funneling engine for automatically transcoding the at least one piece of original content and the at least one piece of targeted advertisement content as it is ingested, resulting in output media having the requirements of the requested composite media; and
a media delivery module for delivering the output media according to the delivery options specified by the end-user.

2. The system for automatically assembling composite media according to claim 1, wherein the content ingestor module is coupled to a media source selected from among: content stored in a database, broadcasted digital media, web-streaming digital media, video on demand content, compact disc player, digital video disc players, high definition digital video disc players, blue-ray disc players, MP3 players, personal data assistant (PDA) devices, Iphone™ devices, smartphones, and hard drives storing digital content.

3. The system for automatically assembling composite media according to claim 1, wherein the browser-based advertiser access point for creating an advertisement campaign further comprises interactive tools for creating a campaign.

4. The system for automatically assembling composite media according to claim 1, wherein the demographic information comprises information selected from among a group consisting of: age, sex, location, familial information, socioeconomic status, language spoke, employment information, consumer activities, shopping habits, recreation activities, and political affiliation.

5. The system for automatically assembling composite media according to claim 1, wherein the entry of delivery options occurs by specifying a type of mobile device the end-user wants output media delivered to, and an electronic delivery address.

6. The system for automatically assembling composite media according to claim 1, wherein the delivery of output media comprises delivering the actual output media file.

7. The system for automatically assembling composite media according to claim 1, wherein the delivery of output media comprises delivering an executable hyperlink to an end-user via an electronic message, and wherein the user is directed to a browser-based access point containing the output media upon executing said hyperlink.

8. The system for automatically assembling composite media according to claim 1, wherein said browser-based advertiser access point comprises interactive tools for tracking metrics relating to said advertisement content.

9. A computer-implemented method for automatically assembling and delivering composite media comprising:
ingesting original content and advertisement content from a plurality of media sources;
creating an advertisement campaign using a browser-based advertiser access point, wherein said browser-based advertiser access point allows providers of advertisement content to specify campaign details including target demographics for their advertisement content, thus defining targeted advertisement content;
integrating interactive tools into the original content, creating an original asset with a media delivery tools, wherein the media delivery tools accept information from an end-user;
providing access to the original asset with a media delivery tools using a browser-based end-user access point, wherein said browser-based end-user access point enables an end-user the ability to request delivery of composite media through entry of media delivery options and demographic information through the media delivery tools, wherein the media delivery options define the requirements for composite media;
defining a composite media asset comprising at least one piece of original content and at least one piece of targeted advertisement content, wherein the demographic information defining the targeted advertisement content matches the user entered demographic information;
automatically transcoding the at least one piece of original content and the at least one piece of targeted advertisement content as it is ingested, resulting in output media having the requirements of the requested composite media; and
delivering the output media according to the delivery options specified by the end-user.

10. The method claim 9, wherein ingesting original content and advertisement content from a plurality of media sources comprises ingesting content from sources selected from among a group consisting of: content stored in a database, broadcasted digital media, web-streaming digital media, video on demand content, compact disc player, digital video disc players, high definition digital video disc players, blue-ray disc players, MP3 players, personal data assistant (PDA) devices, Iphone™ devices, smartphones, and hard drives storing digital content.

11. The method claim 9, wherein delivering output media comprises delivering the actual output media file.

12. The method claim 9, wherein delivering output media comprises delivering an executable hyperlink to an end-user via an electronic message, wherein the user is directed to a browser-based access point containing the output media upon executing said hyperlink.

13. The method claim 9, further comprising storing a copy of the composite media in a server-based database.

14. The method of claim 9, further comprising providing said a browser-based advertiser access with comprises interactive tools for tracking metrics relating to said advertisement content.

15. The method claim 9, wherein the step of automatically transcoding the at least one piece of original content and the at least one piece of targeted advertisement content as it is ingested further comprises:
normalizing at least one of the at least one piece of original content and the at least one piece of targeted advertisement.

16. The method claim 9, wherein the at least one piece of original content and the at least one piece of targeted advertisement are defined by a native frame slot format, and wherein the step of automatically transcoding the at least one piece of original content and the at least one piece of targeted advertisement content as it is ingested further comprises:
sequentially ordering the at least one piece of original content and the at least one piece of targeted advertisement in their native frame slot format, thus defining said composite media asset;
converting the composite media asset from a native frame slot format to a timescale format based on a synchronized clock.

17. The method claim 16, wherein the step of automatically transcoding the at least one piece of original content and the at least one piece of targeted advertisement content as it is ingested further comprises:
defining output frame slots based on the delivery options selected by the end-user, wherein the output frame slots are synchronized to said synchronized clock;
comparing said composite media asset's timescale format to the output frame slots;
identifying frames from the composite media asset that correspond in time with the output frame slots, forming identified frames; and
adding said identified frames to said frame slots sequentially, thus defining said output media.

18. The method claim 17, further comprising:
sequentially overlaying audio components of said at least one piece of original content and the at least one piece of targeted advertisement content over said composite media asset; and
transcoding said audio components based on said synchronized clock, thus defining an audio component of said output media.

19. A computer-implemented method of automatically transcoding a plurality of media files comprising:
sequentially ordering a first media file in a frame slot format and a second media file in a frame slot format, thereby defining a composite media asset;
converting the composite media asset from said native frame slot format to a timescale format based on a synchronized clock;
defining output frame slots based on delivery options selected by an end-user, wherein the output frame slots are synchronized to said synchronized clock;
comparing said composite media asset's timescale format to the output frame slots;
identifying frames from the composite media asset that correspond in time with the output frame slots, forming identified frames;
adding said identified frames to said frame slots sequentially, thus defining an output media.

20. The method claim 20, further comprising:
sequentially overlaying audio components of said first media file and said second media file over said composite media asset; and
transcoding said audio components based on said synchronized clock, thus defining an audio component of said output media.
